(19) United States
(12) Patent Application Publication
(10) Pub. No.: US 2006/0281563 A1
(43) Pub. Date: Dec. 14, 2006

(54) Coupling device for coupling rotatable bodies and transmission system including a coupling device

(76) Inventor: William Wesley Martin, Milton Keynes (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/568,773

(22) PCT Filed: Sep. 6, 2004
(86) PCT No.: PCT/GB04/03794

§ 371 Date: Jul. 24, 2006

(30) Foreign Application Priority Data
Sep. 4, 2003 (GB) 0320703.2

(51) Int. Cl. F16D 3/00

(52) U.S. Cl. 464/75

(57) ABSTRACT

A coupling device including first and second rotatable bodies (1, 3), a plurality of engagement members (27,28) for selectively coupling the first and second rotatable bodies together to transfer drive between the rotatable bodies, and a guard device (2) for preventing the engagement members from coupling the rotatable bodies in certain predetermined operational conditions that include certain relative rotational positions of the rotatable bodies. The coupling device can be used in transmission systems. For example, such a transmission system can include first and second drive shafts (1, 7), first and second gear sets (15, 17) mounted on the shafts for transferring drive between the shafts, each gear set including a first gear wheel (3, 5) mounted o n the first shaft for rotation relative to the first shaft said first gear wheel having a plurality of drive forinations (19, 21), and a second gear (9, 11) mounted on the second shaft for rotation with the second shaft, selector means (13) for selectively transferring drive between the first shaft and either the first or second gear set including a plurality of engagenient members (28, 30) for engaging the drive formations, and a guard device (2, 102, 202, 302) for preventing the engagement members from engaging the drive formations in certain predetermined operational conditions that include certain relative rotational positions of the drive formations and the engagement members.

The present invention relates to a coupling device for coupling rotatable bodies and a transmission system including such a coupling device, for reducing or substantially eliminating wear of some of the transmission components.

In machines where there are first and second rotatable bodies that can be selectively disconnected or connected together to transfer drive between them and there is a possibility that the bodies will be rotating at different speeds when connection is made, it is common to use a clutch arrangement to temporarily disconnect the drive source before coupling the rotatable bodies together to prevent substantial wear on the coupling components. For example, two shafts can each have dog type drive formations located at one end, and at least one of the shafts can be moved axially towards the other shaft such that the dog type drive formations engage. The clutch allows the speed of the rotatable bodies time to be matched before full engagement takes place, thereby reducing the amount of wear on the coupling components. However, including a clutch arrangement in a machine can be costly, particularly if a synchronising device is used to match the speed of the rotating bodies before full engagement takes place.

In some applications, the clutch arrangement may be omitted for cost or operational reasons. For example, a motor may drive a shaft with a first coupling formation until it has reached a predetermined speed at which time it is connected to a load having a complementary coupling formation. The load may be rotating at the time of connection or may be stationary. When the coupling formations engage there is a high risk of wear occurring because of the different rotational speeds of the coupling formations. Without complex control equipment, the coupling formations may collide rather than engaging correctly. In such a situation it is likely that substantial wear will occur to the coupling formations, and that those components will have to be replaced periodically. This approach may bring short-term cost savings but can be highly inconvenient in the long-term since much greater effort is required to maintain the machine.

Similar problems occur in conventional dog type transmission systems as typically used in motor sport. Even though such transmission systems typically include clutch devices, when the dogs associated with a gear wheel are engaged and disengaged by a dog ring a situation can occur where the gear dogs and the dog ring only partially engage and power is transmitted through a reduced contact path, resulting in damage or wear to the dogs. In particular, the corners and edges of the dogs can be rounded off, which affects the performance of the transmission and ultimately may lead to its failure.

In transmission systems where the selection of a new gear ratio takes place almost instantaneously without substantial power interruption, such as the transmissions described in: PCT/GB2004/001976, PCT/GB2004/002946, PCT/GB2004/003021, PCT/GB2004/002955, the contents of which are hereby incorporated by reference, large torque spikes can be generated when the new gear is engaged by a selector assembly under certain shift conditions. These torque spikes cause shock waves to propagate through the transmission that can be heard and felt by the occupants of the vehicle. The shockwaves can produce a jerky ride for the car occupants and can lead to wear of transmission components and the possibility of components failing. For example, significant damage can be caused to engagement members in the selector assemblies and/or drive formations on the gear wheels. When a new gear ratio is selected the engagement members enter windows between drive formations and rotate into engagement with the drive formations. The drive faces of the engagement members and the drive formations engage and there is substantially no wear on the components. In practice, when the driver selects a new gear ratio the relative rotational positions of the engagement members and drive formations are not known and therefore the engagement members may crash into the drive formations, or partially engage therewith, which can cause substantial wear over a period of time or occasionally catastrophic damage. In particular, the leading edges of the engagement members and drive faces are most susceptible to wear.

The above problems can be mitigated by using control systems to control selection of new gear ratios. For example, the control systems described in PCT/GB2004/002946 and PCT/GB2004/002955 limit the amount of torque in the transmission system when a gear change is made thereby reducing the amount of wear caused. However, control systems are complex and can be difficult to implement in practice and therefore it is desirable to have an alternative means of preventing or reducing wear of the transmission components.

Accordingly the present invention seeks to provide a coupling device for coupling rotatable bodies together that mitigates at least some of the aforementioned problems, and a transmission including the coupling device.

According to a first aspect of the invention there is provided a coupling device including first and second rotatable bodies, a plurality of engagement members for selectively coupling the first and second rotatable bodies together to transfer drive between the rotatable bodies, and a guard device for preventing the engagement members from coupling the rotatable bodies in certain predetermined operational conditions that include the relative rotational positions of the rotatable bodies.

The invention can be used to couple first and second rotatable bodies together in any suitable machine where the rotatable bodies are arranged to rotate at different speeds. Advantageously, the coupling device obviates the need for a clutch and/or a synchronising device in such machines since the guard device prevents potentially damaging coupling engagements from taking place and allows coupling engagements where the risk of wear is low. For example, the invention can be used in mining equipment, marine equipment, the oil and gas industries, aerospace applications, manufacturing equipment, pumps, and in any vehicle having a transmission system.

Advantageously the guard device may include at least one guard element for restricting movement of the engagement members. The or each guard element is arranged to precede the engagement members along their rotational paths.

Preferably the or each guard element includes an actuator part arranged to co-operate with either the engagement members or one of the rotatable bodies wherein, in use, the engagement members couple the rotational bodies after the actuator part co-operates with either the engagement members or one of the rotatable bodies. Preferably the or each guard element includes a guard part arranged to co-operate with either the engagement members or one of the rotatable bodies, wherein, in use, the engagement members are restricted from coupling the rotatable bodies after the guard part co-operates with either the engagement members or one of rotatable bodies. The guard part of the or each guard element is arranged to ensure that the engagement members do not engage one another as they align after the guard part co-operates with either the engagement members or one of rotatable bodies. This prevents damaging contacts between the engagement members, for example contacts close to the edges of the engagement members.

Advantageously the or each guard element can be arranged to cause separation between the engagement members and one of the rotatable bodies. Preferably the or each guard element is arranged to cause the separation according to the relative rotational positions of the engagement members and at least one of the rotational bodies. Preferably the guard part of the or each guard element is arranged such that the or each guard element increases the separation between the engagement members as the rotational distance between them decreases for a predetermined amount of relative rotational movement. This causes the engagement members to clear one another as they align.

In some embodiments each of the engagement members includes a guard element mounted thereon. In a preferred embodiment each guard element is pivotally mounted on the engagement member. Preferably each guard element is arranged to move between a first operative position in which it restricts movement of the engagement member and a second operative position in which it does not restrict movement of the engagement member. Preferably the guard device includes resilient means for biasing each guard element into the first operative position. Advantageously pairs of guard elements are arranged to interact such that rotational movement of one of the pair of guard elements causes rotational movement of the other guard element.

Advantageously at least one of the rotatable bodies may include profiled parts that are complementary to the actuator part of the guard element. Preferably at least one of the rotatable bodies includes profiled parts that are complementary to the guard part of the guard element.

In one embodiment the or each guard element is mounted on an annular member. Preferably the or each guard element is substantially trapezoidal and each guard element includes a guide part arranged to guide the engagement members over the or each guard element. Preferably the guard device includes resilient means for resisting relative rotational movement between the annular member and at least one of the rotatable bodies.

In another embodiment the or each guard element is mounted on at least one of the rotatable bodies. Preferably the engagement members include profiled parts that are complementary to the or each guard element.

Advantageously the engagement members can fixed to the rotatable bodies and move rotationally and translationally therewith. Alternatively, at least one of the engagement members can be arranged for relative translational movement with respect to the rotatable bodies.

According to a second aspect of the invention there is provided a transmission system including first and second drive shafts, first and second gear sets mounted on the shafts for transferring drive between the shafts, each gear set including a first gear wheel mounted on the first shaft for rotation relative to the first shaft said first gear wheel having a plurality of drive formations, and a second gear mounted on the second shaft for rotation with the second shaft, selector means for selectively transferring drive between the first shaft and either the first or second gear set including a plurality of engagement members for engaging the drive formations, and a guard device for preventing the engagement members from engaging the drive formations in certain predetermined operational conditions that include the relative rotational positions of the drive formations and the engagement members.

The invention is used to prevent contact between the engagement members and the drive formations associated with the first gear wheel when the risk of wear or damage to the components is high, and to allow the components to engage when the risk of wear is low. This extends the life of the transmission and reduces the amount of effort required to maintain it.

Advantageously the guard device includes a plurality of guard elements for restricting movement of the engagement members. Preferably the guard elements are arranged as buffers between the drive formations and the engagement members and each guard element includes an actuator part arranged to co-operate with either the engagement members or the drive formations, the guard device being constructed and arranged such that, in use, the engagement members fully engage the drive formations after the actuator part co-operates with either the engagement members or the drive formations.

Preferably each guard element includes a guard part arranged to co-operate with either the engagement members or the drive formations, the guard device being constructed and arranged such that, in use, the engagement members are restricted from engaging the drive formations after the guard part co-operates with either the engagement members or the drive formations.

The engagement members attempt to move into windows between the drive formations when a gear selection is made. If this is successful, further relative rotational movement between the drive formations and the engagement members causes one of those components to interact with the actuator part of the guard elements. This interaction allows the engagement members to fully engage the drive formations. When the engagement members enter the windows between drive formations the risk of damaging contact is lower and therefore the guard device is arranged to allow the engagement members to engage the drive formations. If the engagement members try to engage the drive formations within the predetermined range of relative rotational positions between the engagement members and the drive formations the risk of damaging contact is higher. If this instance occurs, the guard elements are arranged such that either the engagement members or the drive formations interact with the guard parts of the guard elements, thereby preventing engagement.

Advantageously the guard elements can be arranged to cause separation between the engagement members and the drive formations. Preferably the guard elements are arranged to determine the separation according to the relative rotational positions of the drive formations and the engagement members. For example, the guard elements can be arranged to increase the axial distance between the engagement members and the drive formations as the rotational distance between them decreases for a predetermined amount of relative rotational movement. This causes the engagement members to clear the drive formations as they align.

Preferably first and second guard elements are associated with each drive formation, wherein the first guard element is arranged to restrict movement of engagement members approaching the drive formation from a first rotational direction and the second guard element is arranged to restrict movement of engagement members approaching the drive formation from a second rotational direction. The first and second guard elements guard the drive formation bi-directionally, for example under conditions of acceleration and deceleration.

In some embodiments each of the engagement members includes a guard element mounted thereon. Each guard element can be mounted directly on the engagement member or can be mounted on an intermediate component. In one embodiment the guard element is formed integrally with the engagement member. For transmissions having selector means including a plurality of engagement members a guard element can be mounted on each engagement member.

In a preferred embodiment each guard element is pivotally mounted on the engagement member. Each guard element is arranged to move between a first operative position in which it can restrict the movement of the engagement member and a second operative position in which it cannot. Preferably the guard device includes resilient means for biasing each guard element into the first operative position. For example, the resilient means can be a spring arranged to bias the guard element against the engagement member. Preferably pairs of guard elements are arranged to interact such that rotational movement of one of the guard elements in the guard element pair causes rotational movement of the other guard element. Rotation of one of the guard elements causes the other guard element to rotate in the opposite direction. This allows a gap to be created adjacent the drive formation to allow a further engagement member to move into the gap.

In some embodiments the drive formations include profiled parts that are complementary to the first part of the guard element.

In another preferred embodiment the guard elements are mounted on an annular member. Preferably the annular member is mounted on at least one of the first gear wheels and is arranged to surround the drive formations. Preferably the guard elements are substantially trapezoidal and each guard element includes a guide part arranged to guide the engagement members over the guard elements. The guard device may include resilient means for resisting relative rotational movement between the annular member and the first gear wheel. Preferably the resilient means is arranged to bias the annular member towards a neutral position wherein the guard elements are located adjacent the drive formations. If the engagement members enter the windows between the drive formations when a gear selection is made, the engagement members engage the actuator parts of the-guard elements and drive the annular member. There is relative rotational movement between the annular member and the first gear wheel against the bias of the resilient means, until the engagement members engage the drive formations. If the engagement members are within the predetermined range of relative rotational positions when a gear selection is made, the engagement members interact with the guard parts of the guard elements and the guard elements restrict movement of the engagement members, thereby preventing them engaging with the drive formations.

In another embodiment the guard elements are mounted on the drive formations and the engagement members include profiled parts that are formed complementary to the guard elements.

The transmission system may be arranged such that the selector means includes an actuator assembly and at least one set of engagement members that are moveable into and out of engagement with the first gear wheels such as in a conventional dog system.

The transmission system may be arranged such that the selector means includes an actuator assembly and first and second sets of engagement members that are moveable into and out of engagement with the first gear wheels independently of each other, said selector means being arranged such that when a driving force is transmitted, one of the first and second sets of engagement members drivingly engages the engaged gear wheel, and the other set of engagement members is then in an unloaded condition, wherein the actuator assembly is arranged to move the unloaded set of engagement members into driving engagement with the unengaged gear wheel to effect a gear change.

Preferably the selector means is arranged such that when a braking force is transmitted the first set of engagement members drivingly engages the engaged gear wheel, and the second set of engagement members is in an unloaded condition, and when a driving force is transmitted the second set of engagement members drivingly engages the engaged gear wheel, and the second set of engagement members is then in an unloaded condition.

Advantageously the actuator assembly is arranged to bias the loaded set of engagement members towards the unengaged gear wheel without disengaging the loaded set of engagement members from the engaged gear wheel.

The first and second sets of engagement members are arranged to rotate, in use, with the first shaft. The selector assembly is arranged such that the first and second sets of engagement members can move axially relative to each other along the first shaft. The first and second sets of engagement members are axially aligned when both sets engage the first gear wheels.

Advantageously the actuator assembly includes at least one resiliently deformable means arranged to move at least one of the first and second sets of engagement members into engagement with the first gear wheels when the engagement members are in unloaded conditions. The at least one resiliently deformable means is arranged to bias at least one of the first and second sets of engagement members towards the gear wheels when the engagement members are drivingly engaged with a gear wheel. In one embodiment the at least one resiliently deformable means is connected to the first and second sets of engagement members such that the resiliently deformable means acts on both the first and second sets of engagement members.

Alternatively the transmission system can be a conventional dog transmission system.

An embodiment of the present invention will now be described, by way of example only, with reference to the accompanying drawings in which like references indicate equivalent features, wherein:

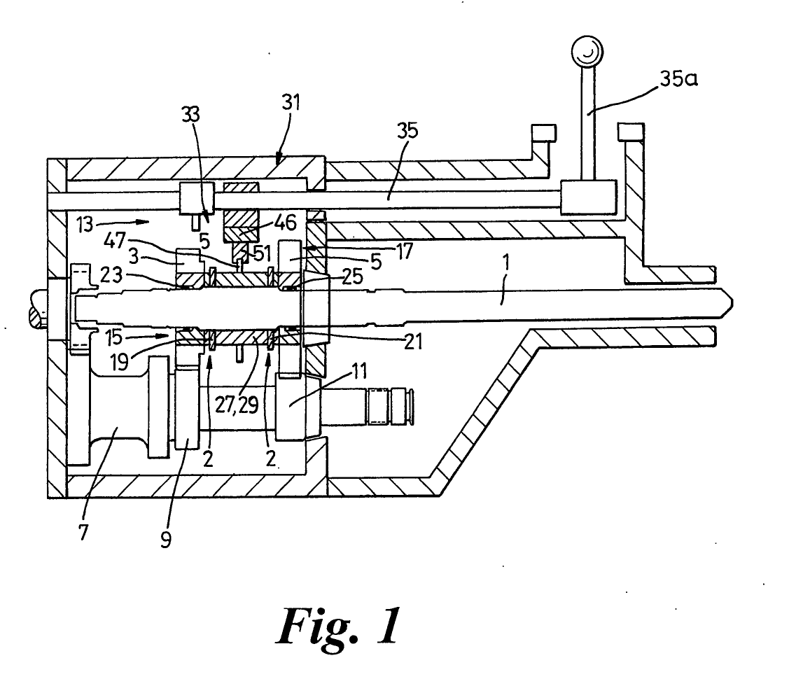

FIG. 1 is a general arrangement of a transmission system including two guard mechanisms in accordance with the present invention;

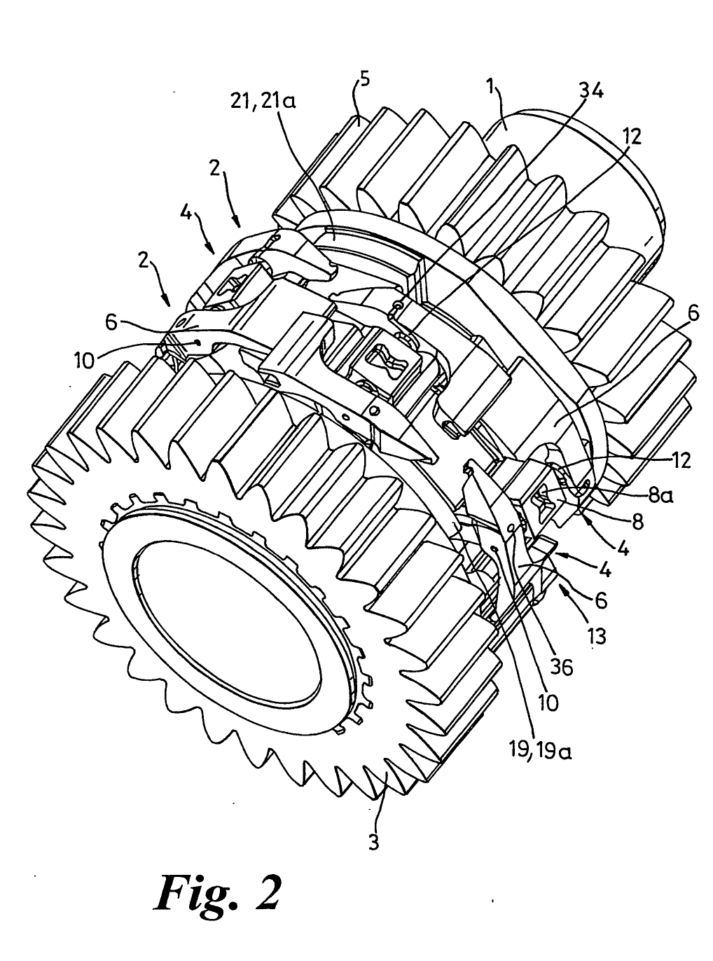

FIG. 2 is a perspective view of a selector assembly including two guard mechanisms according to a first embodiment of the invention mounted between first and second gear wheels;

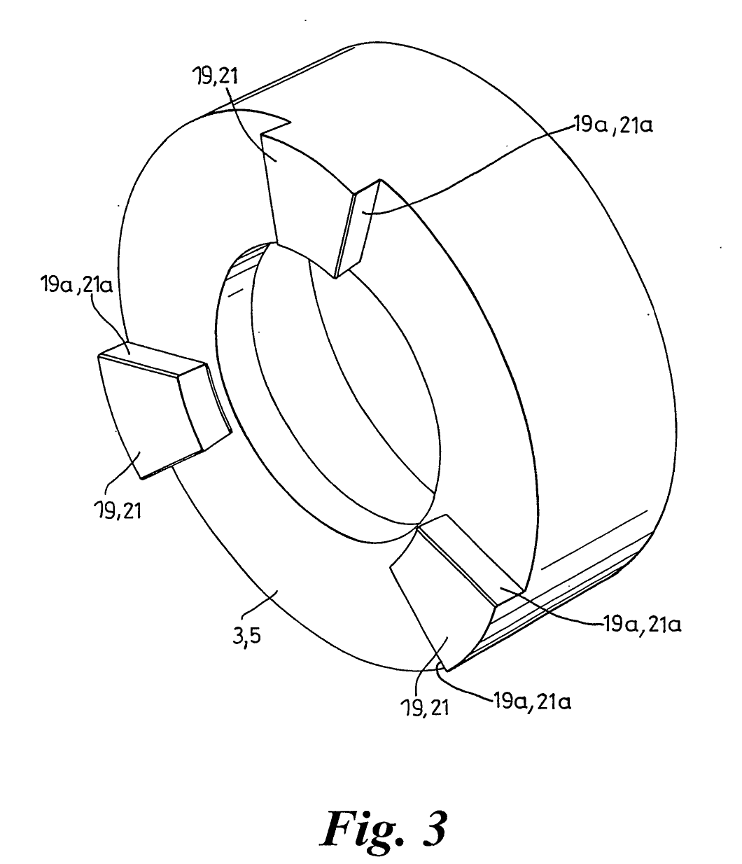

FIG. 3 shows the arrangement of a group of dogs on a gear wheel (gear wheel teeth omitted for clarity);

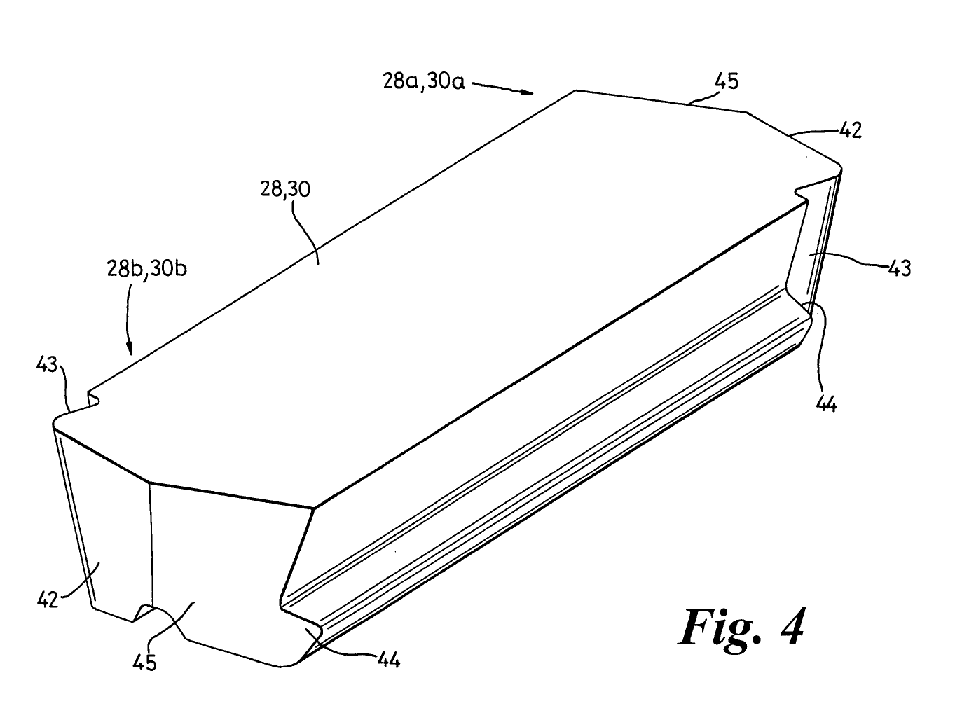

FIG. 4 is a perspective view of an engagement bar;

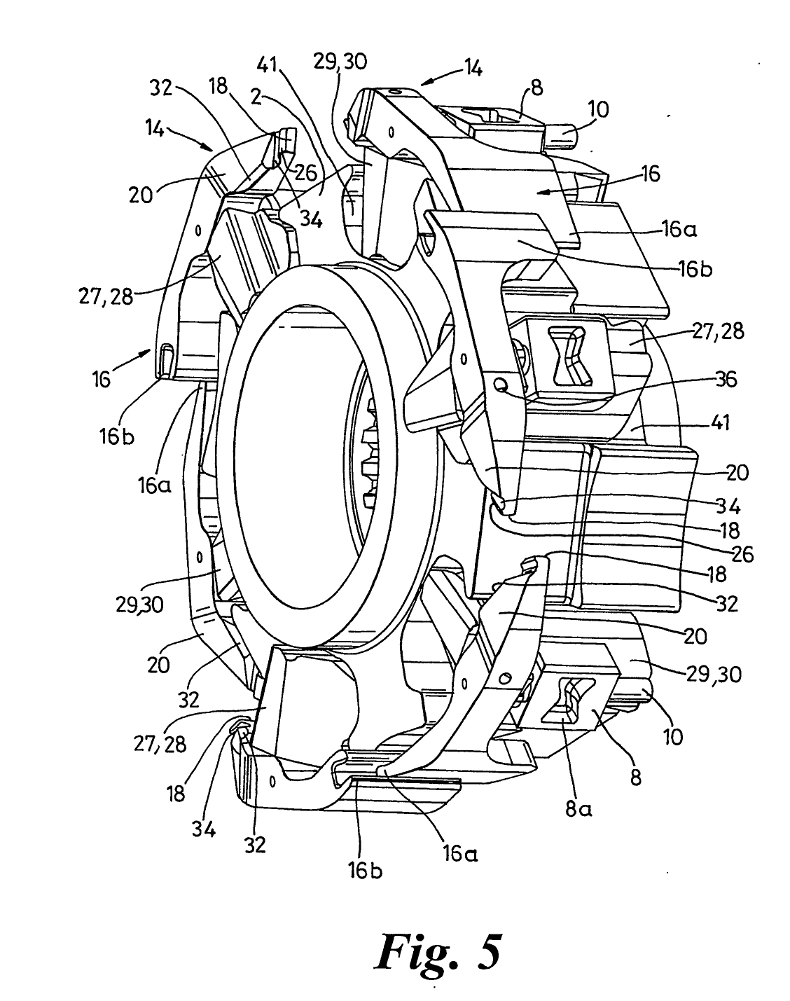

FIG. 5 is a perspective view of the selector assembly of FIG. 2 including a guard mechanism in accordance with the first embodiment of the invention;

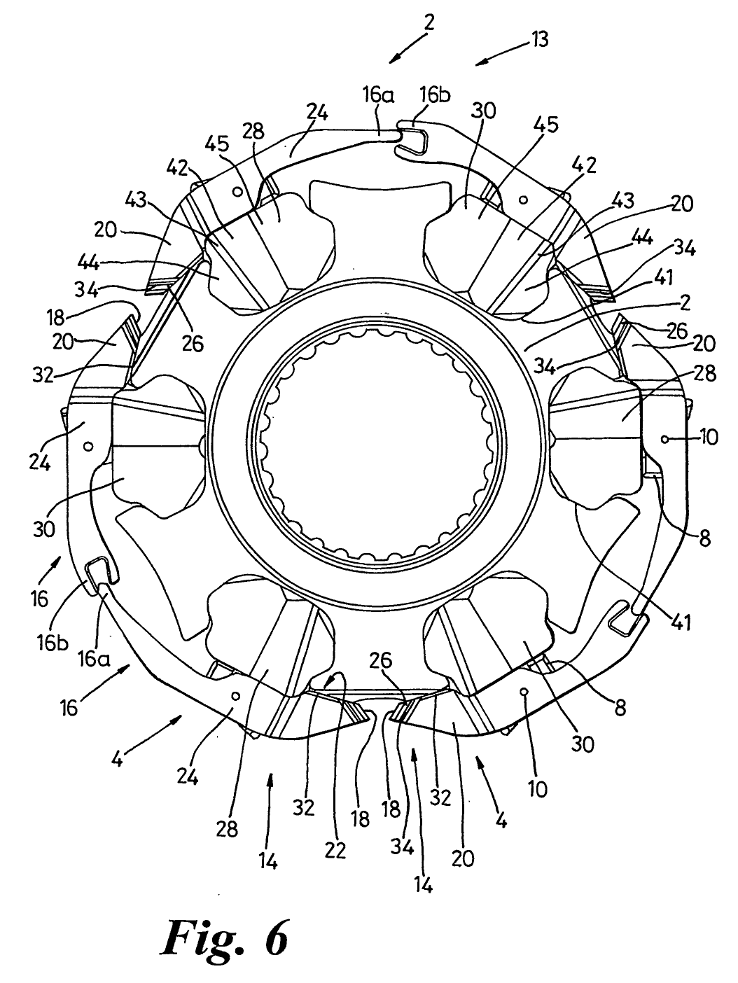

FIG. 6 is an end view of the selector assembly and guard mechanism of FIG. 5 with the guard arms in a start (protective) position;

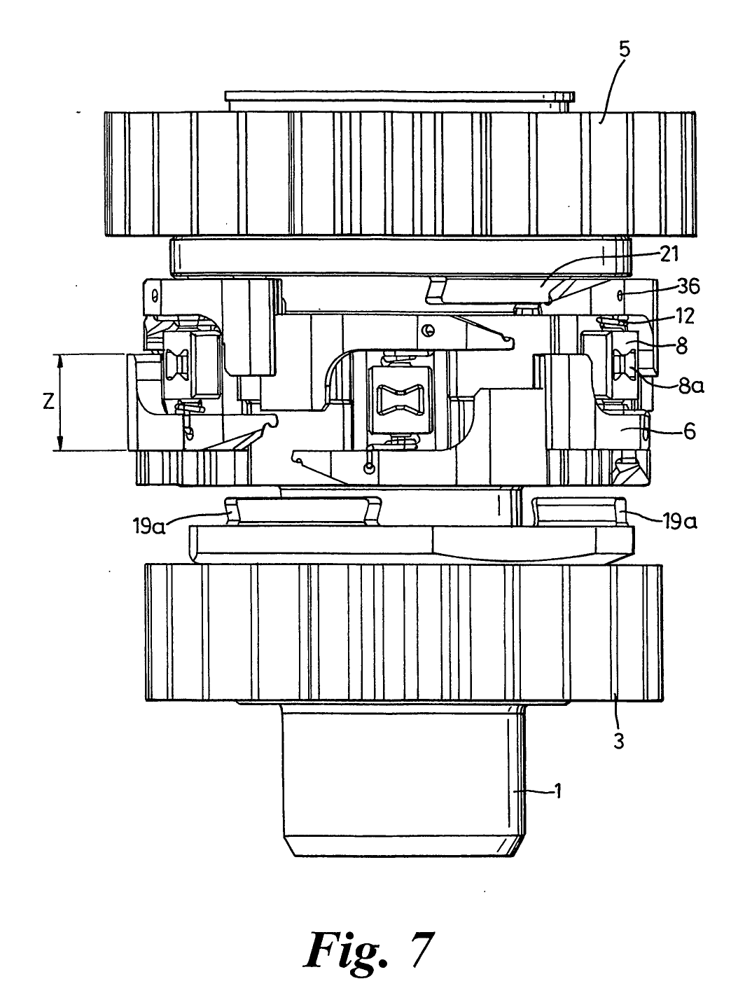

FIG. 7 is a side view of the selector assembly including two guard mechanisms according to the first embodiment of the invention;

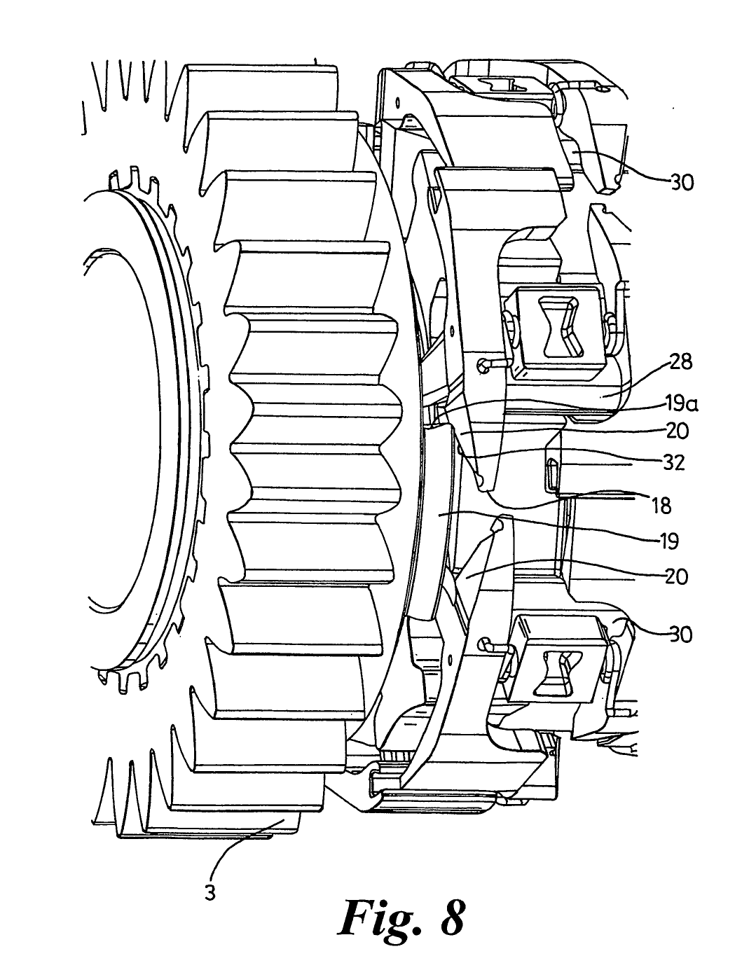

FIG. 8 is a detailed perspective view of part of the selector assembly and the guard mechanism according to the first embodiment of the invention;

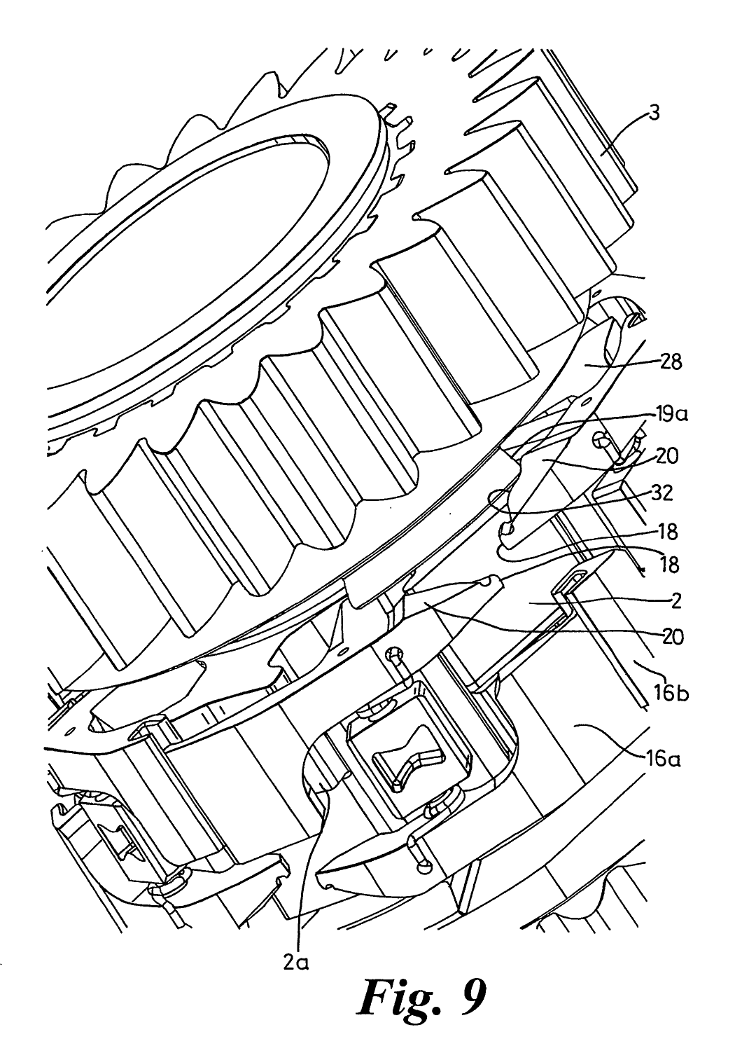

FIG. 9 is a detailed perspective view of part of the selector assembly and guard mechanism according to the first embodiment of the invention;

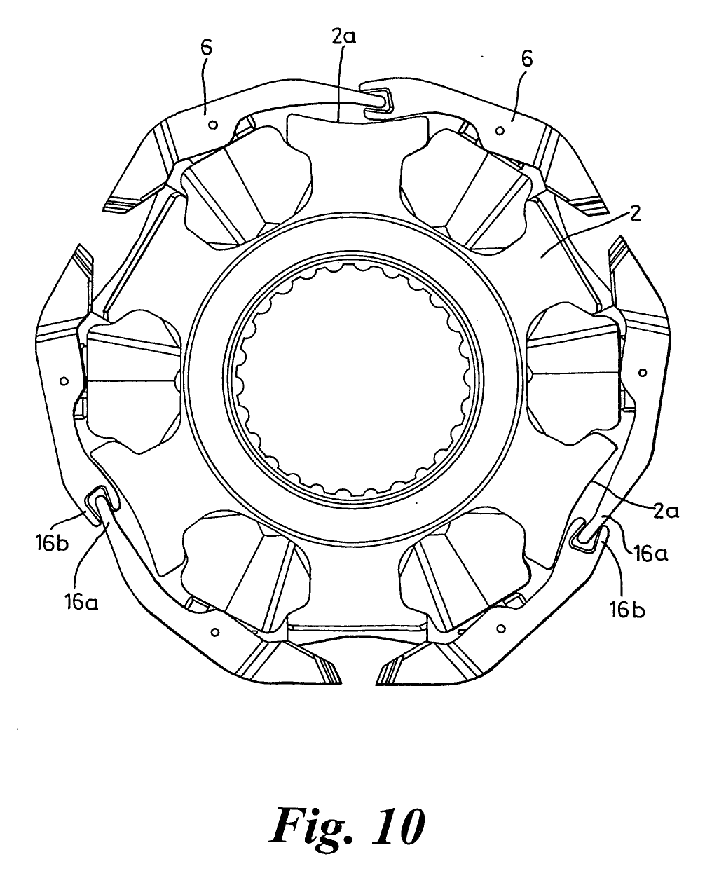

FIG. 10 is an end view of the selector assembly and the guard mechanism of FIG. 6 with guard arm tails rotated inwards;

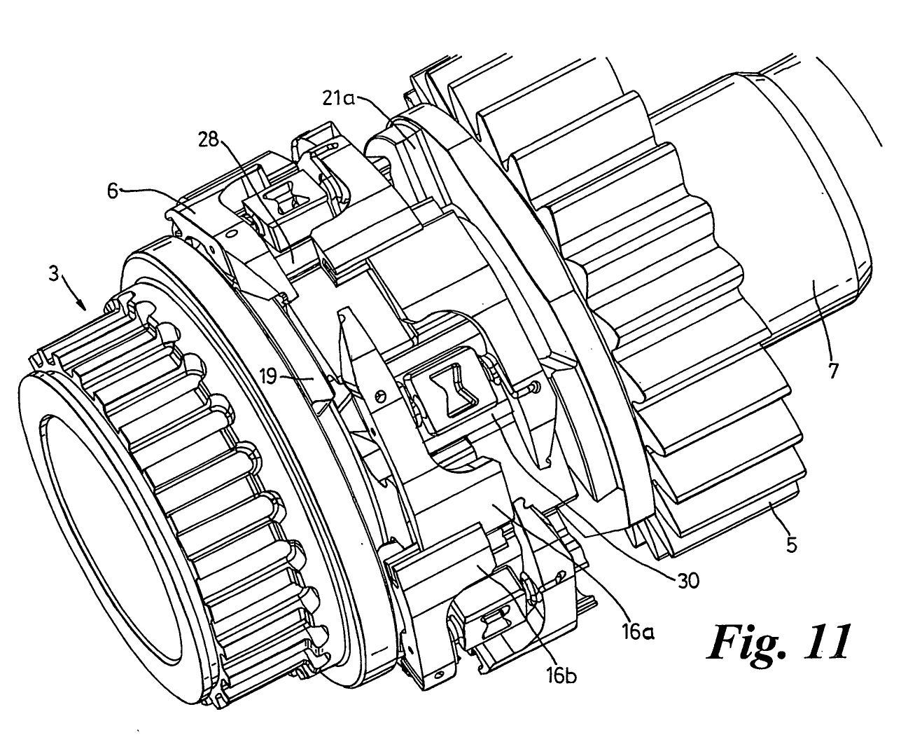

FIG. 11 is a perspective view of the selector assembly including two guard mechanisms according to with the first embodiment of the invention;

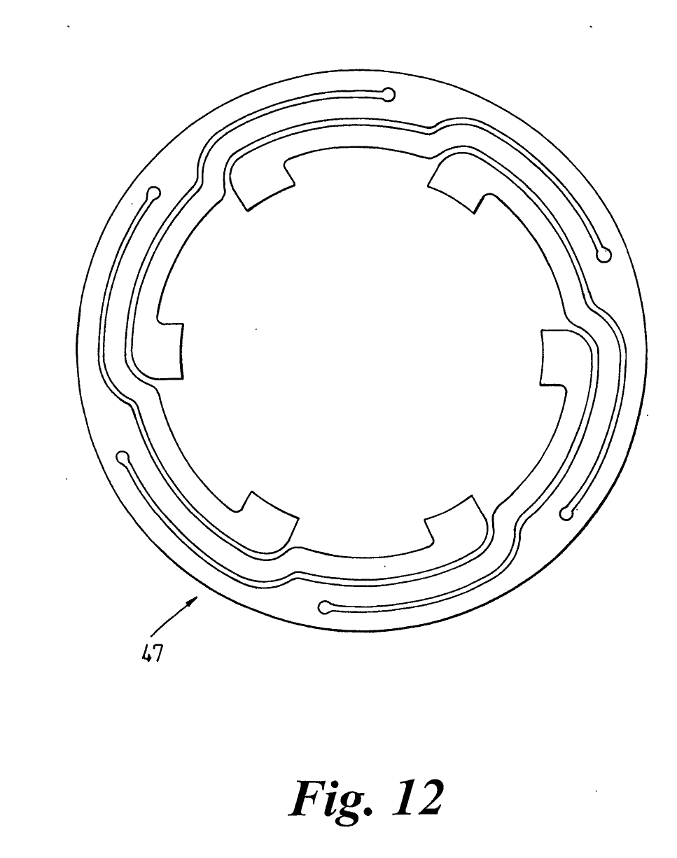

FIG. 12 is a plan view of a disc spring;

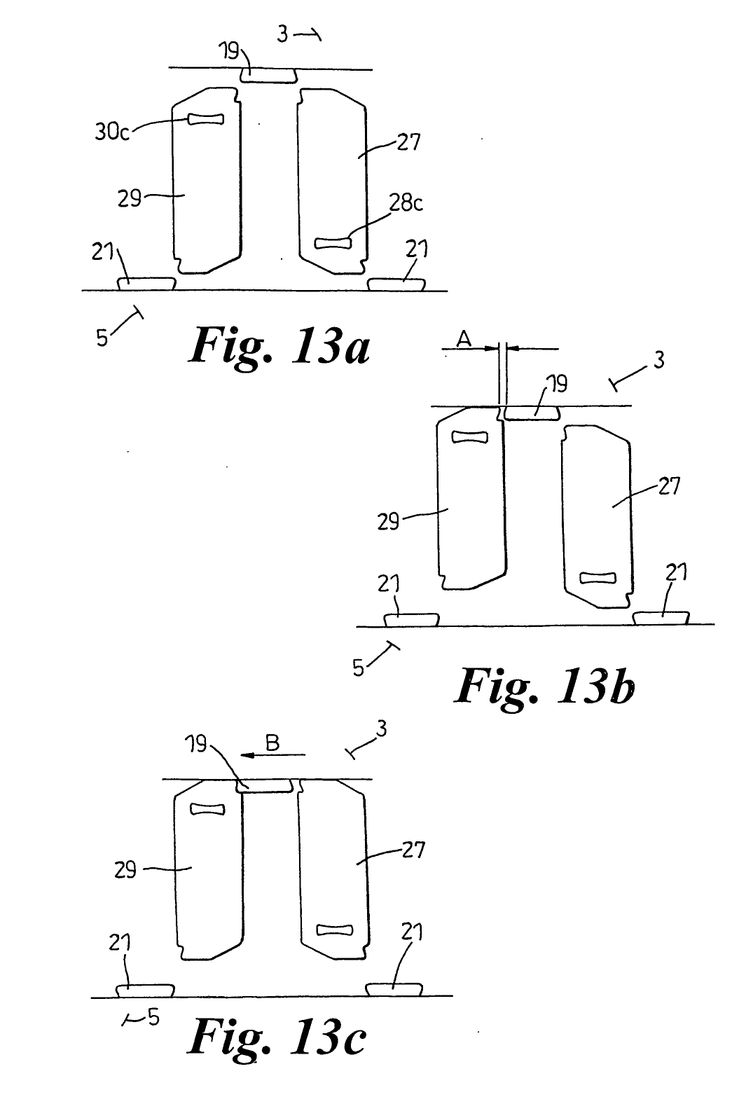

FIGS. 13a-f illustrate diagrammatically operation of the selector assembly;

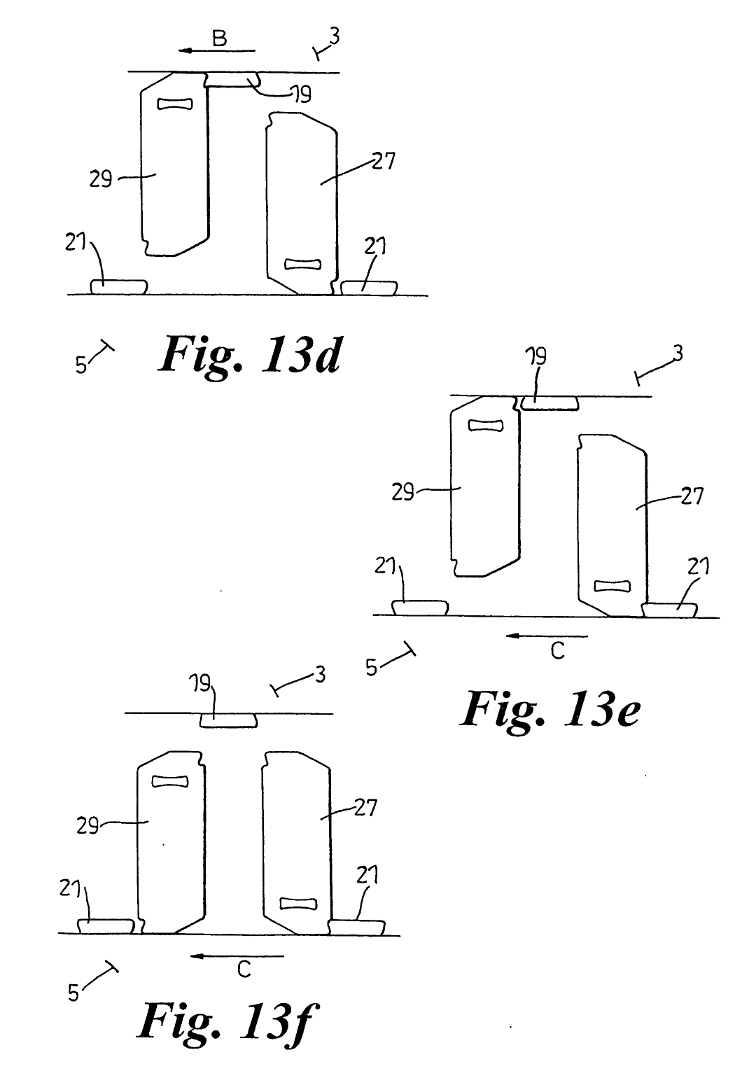

FIG. 14 is a perspective view of an alternative arrangement of first and second bar sets that can be used in accordance with the invention;

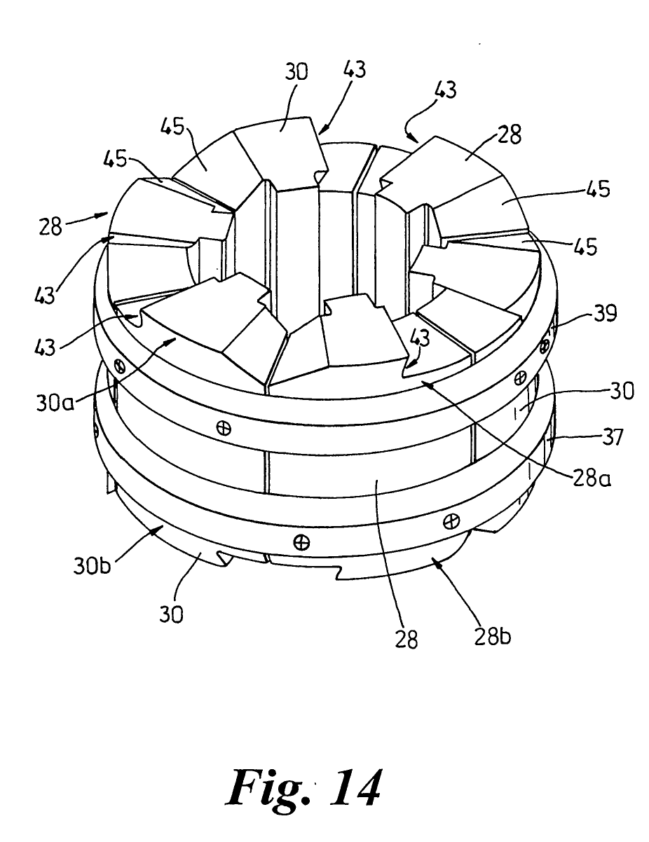

FIG. 15 is a plan view of a disc spring for the bar sets of FIG. 14;

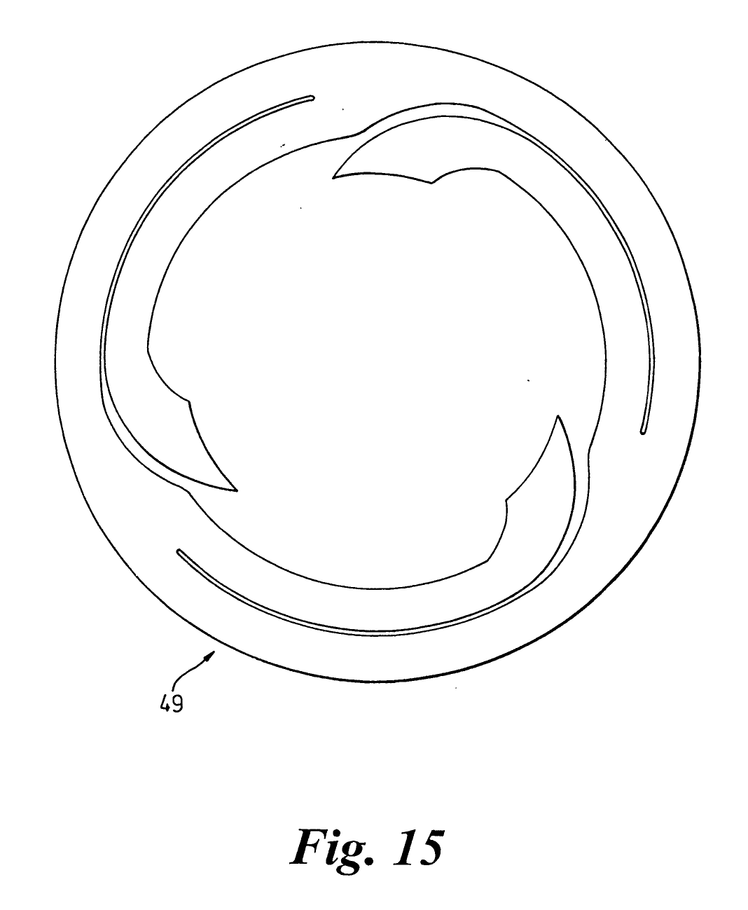

FIG. 16 is an exploded perspective view from above of a guard mechanism according to a second embodiment of the invention;

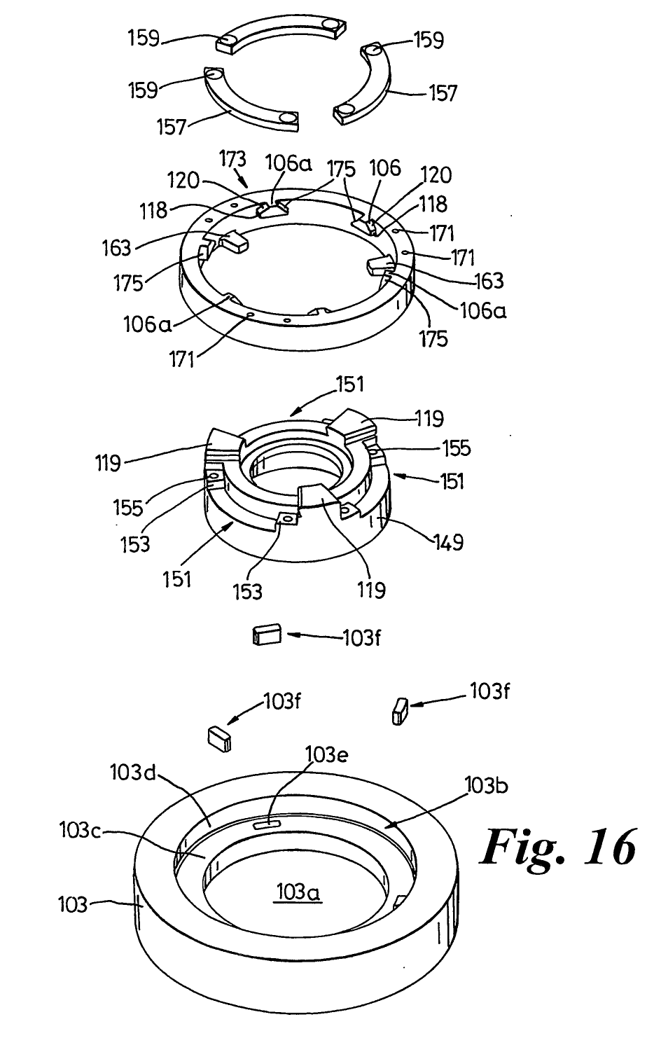

FIG. 17 is an exploded perspective view from below of a guard mechanism according to the second embodiment of the invention;

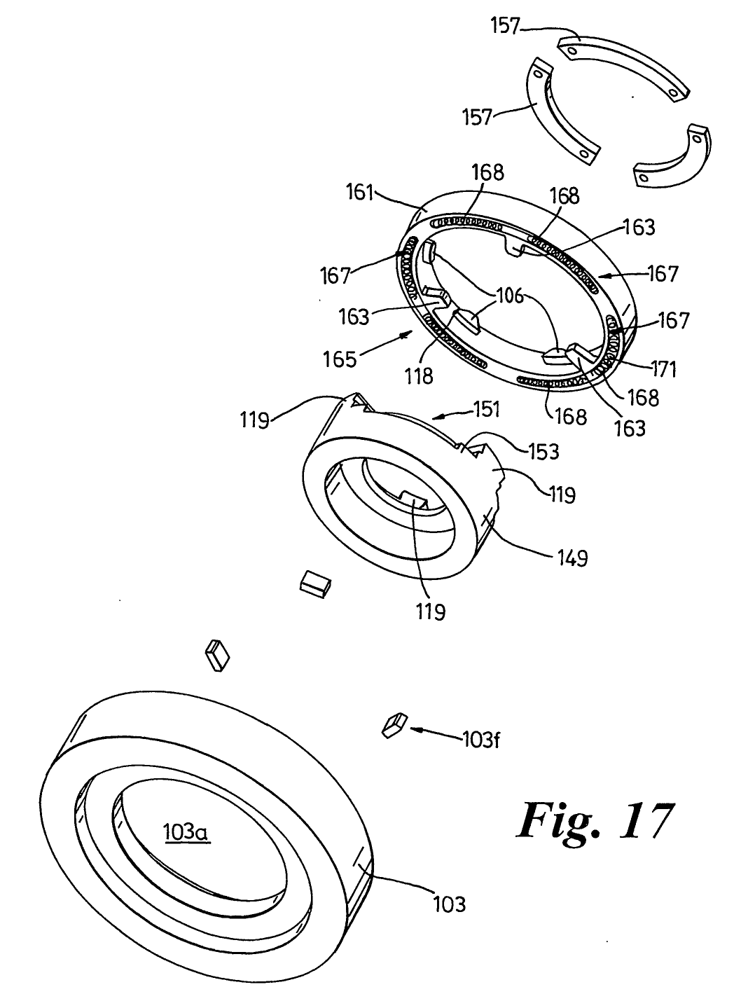

FIG. 18 is a perspective view of a guard mechanism according to the second embodiment of the invention mounted on the first gear wheel;

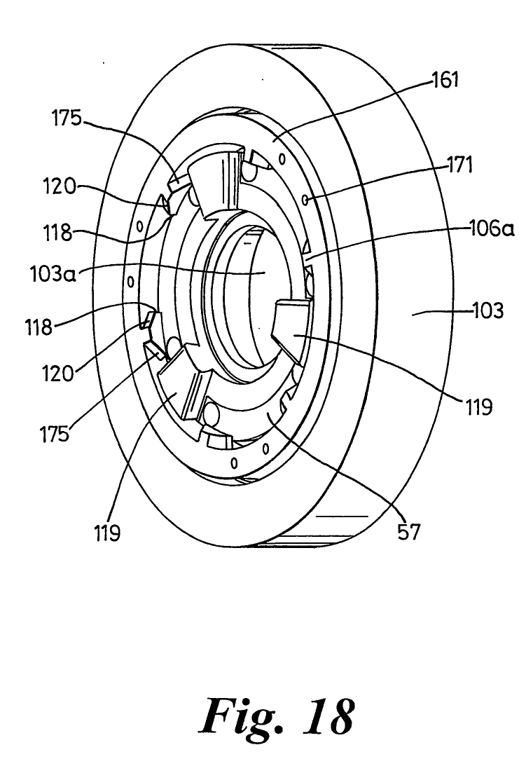

FIG. 19 is a perspective view of the second embodiment of the invention with a cut away section;

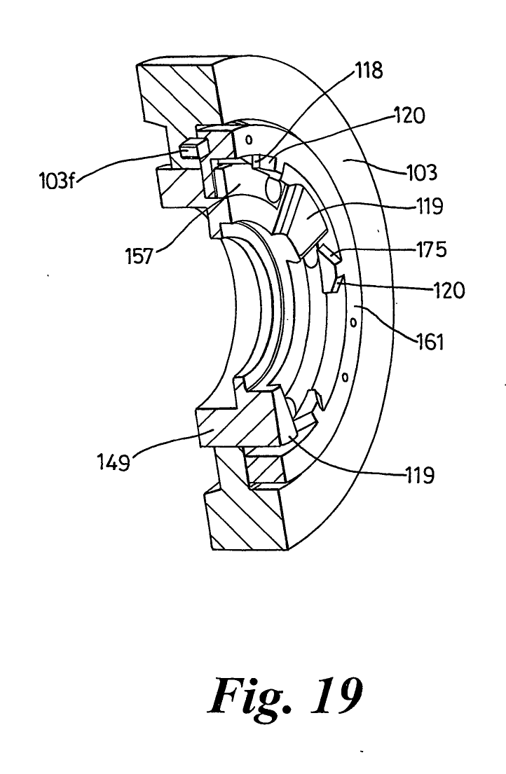

FIG. 20 is a perspective view of a gear wheel including part of a guard mechanism according to a third embodiment of the invention;

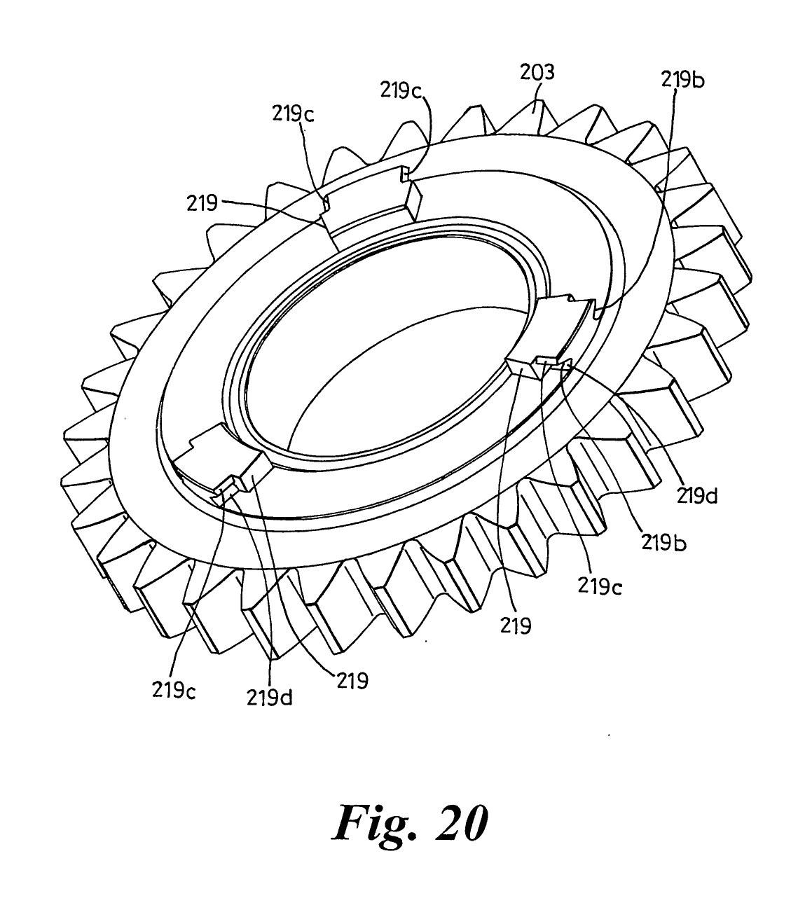

FIG. 21 is a perspective view of a guard arm from a guard mechanism according to the third embodiment of the invention;

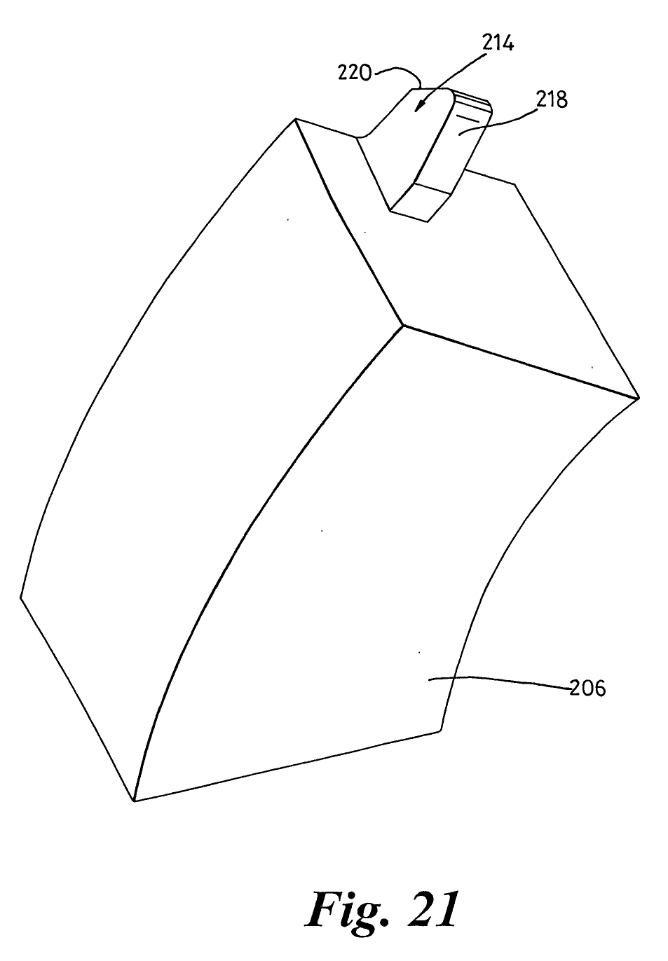

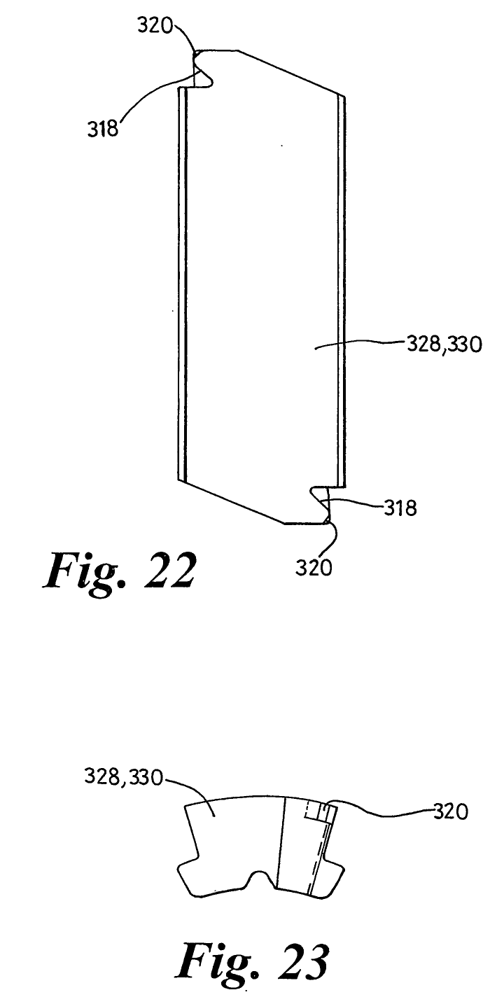

FIGS. 22 and 23 are plan and end views respectively of an engagement bar from a guard mechanism according to a fourth embodiment of the invention; and

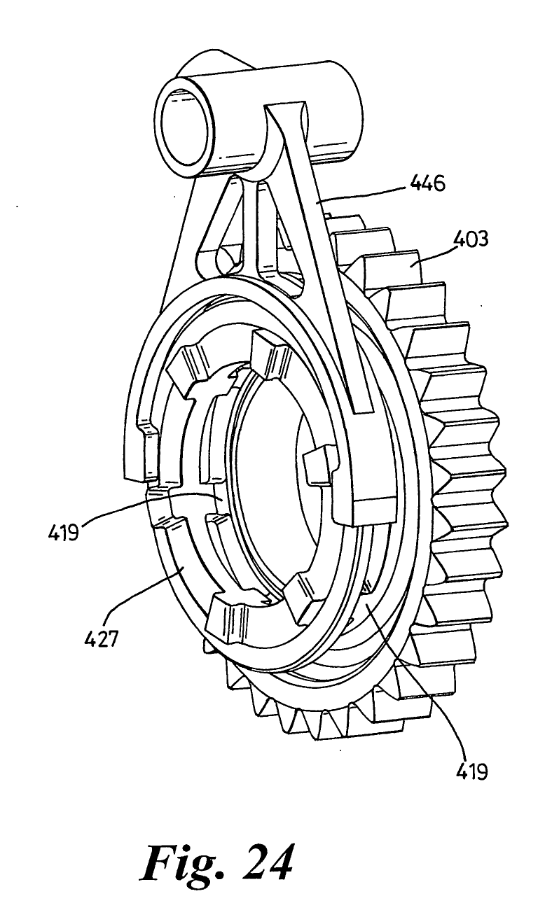

FIG. 24 shows part of a conventional dog transmission.

FIG. 1 shows a transmission system that includes a guard mechanism in accordance with the invention. The transmission system comprises an output shaft 1 having first and second gear wheels 3,5 mounted thereon, an input shaft 7 having third and fourth gear wheels 9,11 mounted thereon and a selector assembly 13. The first and second gear wheels 3,5 are rotatably mounted on the output shaft 1 and the third and fourth gear wheels 9,11 are fixedly mounted on the input shaft 7. The first and second gear wheels 3,5 mesh with third and fourth gear wheels 9,11 respectively to form first and second gear wheel pairs 15,17. The transmission also includes guard mechanisms 2 for controlling engagement of the first and second gear wheels 3,5 by the selector assembly 13 (see FIG. 2).

Rotational drive may be transferred from input shaft 7 to the output shaft 1 via either the first or second gear wheel pairs 15,17, with selection of the operative gear wheel pair being determined by the position of the selector assembly 13. The selector assembly 13 engages first and second groups of drive formations 19,21 located on the first and second gear wheels 3,5 respectively. The drive formations each comprise a group of dogs.

The first dog group 19 is located on one side of the first gear wheel 3. This is shown in FIG. 3 wherein the gear teeth of the gear wheel have been omitted for clarity. The dogs are preferably formed integrally with the first gear wheel, but this is not essential. The first dog group 19 comprises three dogs evenly distributed about the gear face, i.e. the angle subtended between the centres of a pair of dogs is approximately 120°. The sides 19a of the dogs are planar and may be formed with a retention angle. The second dog group 21 comprises three dogs and is similarly arranged to the first gear wheel on one side of the second gear wheel 5. This is shown in FIG. 3. Three dogs are used because the spaces between the dogs this arrangement provide large engagement windows to receive the selector assembly 13. Large engagement windows provide greater opportunities for the selector assembly to fully engage the gear wheels 3,5 before transmitting drive thereto or being driven therefrom. If the selector assembly 13 drives a gear wheel when only partially engaged it can lead to damage of the dogs and/or the selector assembly 13.

The first and second gear wheels 3,5 are mounted spaced apart on the output shaft 1 on roller bearings 23,25 and are arranged such that the sides including the first and second dog groups 19,21 face each other.

The selector assembly 13 includes first and second sets of engagement bars 27,29 and an actuator assembly 31 in the form of a fork assembly 33 and a selector rod 35.

The first and second sets of engagement bars 27,29 are mounted on the output shaft 1 between the first and second gear wheels 3,5. The first set of engagement bars 27 comprises three bars 28 that are evenly distributed about the output shaft 1 such that their bases face inwards, and the axes of the bars 28 are substantially parallel. The second set of engagement bars 29 comprises three bars 30 which are similarly arranged about the output shaft 1.

The first and second engagement bar sets 27,29 are mounted on a sleeve 2 which is mounted on the output shaft 1 between the first and second gear wheels 3,5 (see FIG. 5). The sets of engagement bars 27,29 are arranged to rotate with the output shaft 1 but are able to slide axially along the sleeve 2 and the output shaft 1 in response to a switching action of the actuator assembly 31. To facilitate this, the sleeve 2 includes six keyways 41 formed in its curved surface with each engagement bar 28,30 having a complementary formation in its base. The keyways 41 have substantially T-shaped profiles such that the bars are radially and tangentially (but not axially) restrained within the keyways 41 (see FIG. 6). Alternatively, the keyways 41 can have slotted or dovetailed profiles to radially restrain the bars.

The arrangement of the bar sets 27,29 is such that bars of a particular set are located in alternate keyways 41 and the bar sets 27,29 can slide along the sleeve 2. Each bar set 27,29 moves as a unit and each bar set can move independently of the other.

Preferably the bars are configured to be close to the output shaft 1 to prevent significant cantilever effects due to large radial distances of loaded areas thus reducing the potential for structural failure.

Each bar 28 in the first bar set 27 has a first end 28a arranged to engage the first group of dogs 19 attached to the first gear wheel 3 and a second end 28b arranged to engage the second group of dogs 21 on the second gear wheel 5 (see FIG. 4). The first and second ends 28a,28b typically have the same configuration but are opposite handed, such that the first end 28a is arranged to engage the first group of dogs 19 during deceleration of the first gear wheel 3 and the second end 28b is arranged to engage the second group of dogs 21 during acceleration of the second gear wheel 5, for example during engine braking in automotive applications. Each bar 30 in the second bar set 29 is similarly arranged, except that the first end 30a is arranged to engage the first group of dogs 19 during acceleration of the first gear wheel 3 and the second end 30b is arranged to engage the second group of dogs 21 during deceleration of the second gear wheel 5.

When both the first and second sets of engagement bars 27,29 engage a gear wheel drive is transmitted from the input shaft 7 to the output shaft 1 whether the gear is accelerating or decelerating.

The first and second ends 28a,30a,28b,30b of the bar each include an engagement face 43 for engaging the dogs 19,21, a ramp 45, an end face 42 and a shoulder 44 (see FIGS. 4 and 6).

The end faces 42 limit the axial movement of the engagement bars 28,30 by abutting the sides of the gear wheels. The engagement faces 43 are angled to complement to the sides of the dogs 19a,21a so that as the engagement bars 28,30 rotate into engagement therewith there is face-to-face contact to reduce wear. Each ramp 45 is helically formed and slopes away from the end face 42. The angle of inclination of the ramp 45 is such that the longitudinal distance between the edge of the ramp rest from the end face 42 and the plane of the end face 42 is larger than the height of the dogs 19,21. This ensures that the transmission does not lock up when there is relative rotational movement between the engagement bars 28,30 and the dogs 19,21 that causes the ramp 45 to move towards engagement with the dogs 28,30. The dogs 19,21 do not crash into the sides of the engagement bars 28,30 but rather engage the ramps 45. As further relative rotational movement between the dogs 19,21 and the engagement bars 28,30 occurs, the dogs 19,21 slide across the ramps 45 and the helical surfaces of the ramps cause the engagement bars 28,30 to move axially along the output shaft 1 away from the dogs 19,21 so that the transmission does not lockup.

When the bars of the first and second sets 27,29 are interleaved, as in FIG. 5, the engagement faces 43 of the first ends 28a of the first set of bars 27 are adjacent the engagement faces 43 of the first end 30a of the second set of bars 29. When the first and second sets of bars 27,29 are fully engaged with a gear a dog is located between each pair of adjacent engagement faces 43. The dimensions of the dogs 19,21 and the ends of the bars are preferably such that there is little movement of each dog between the engagement face 43 of the acceleration bar and the engagement face 43 of the deceleration bar when the gear moves from acceleration to deceleration, or vice versa, to ensure that there is little or no backlash in the gear.

The guard mechanisms 2 are arranged to prevent engagement between the bars 28,30 and the dogs 19,21 that will cause those components to wear, and to allow engagement between the bars 28,30 and the dogs 19,21 that will not lead to significant wear. Each guard mechanism 2 controls engagement of one of the gear wheels 3,5. The guard mechanisms 2 are similar, and for the sake of clarity the guard mechanism for the first gear wheel 3 will now be described with reference to FIGS. 2 and 5 to 11.

The guard mechanism 2 comprises six guard arm assemblies 4, said guard arm assemblies each including a guard arm 6, a guard arm support 8 having a pivot pin 10, and a spring 12 for biasing rotational movement of the guard arm 6. Each guard arm assembly 4 is mounted on one of the engagement bars 28,30 in the first and second engagement bar sets 27,29. Each guard arm support 8 is mounted on the upper surface of each engagement bar 28,30 and is arranged substantially parallel thereto. In this embodiment the guard arm supports 8 are separate components from the engagement bars 28,30: however the supports 8 can be formed integrally with the engagement bars 28,30. Each pivot pin 10 is located at one end of the respective guard arm support 8 and is arranged substantially co-axially therewith. The guard arms 6 are mounted on the pivot pins 10 slightly behind the end face 42 of each engagement bar 28,30 to prevent them from crashing into the gear wheel 3, which would inhibit their ability to rotate on the pivot pins 10.

Each support 8 also includes a second pivot pin 10 at its opposite end for supporting a guard arm 6 of the guard mechanism 2 for the second gear wheel 5.

The guard arms 6 allow the engagement bars to engage the dogs during predetermined windows of opportunity relating to the relative rotational positions of the engagement bars and the dogs 19, and prevent engagement when the relative rotational positions are outside of the windows of opportunity. The guard arms 6 each have a fore portion 14 and a tail 16, and are pivotally mounted on the pivot pins 10 such that the fore portions 14 of the guard arms overhang the engagement bars 28,30, thereby preceding the engagement bars, such that the fore portions 14 match with the engagement faces 43 of the bars 28,30. That is, the fore portions 14 of the guard arms mounted on the bars 28 of the first bar set 27 all point in the same rotational direction as the engagement faces 43 of those bars 28 (anti-clockwise in FIG. 6) and the fore portions 14 of the guard arms mounted on the bars 30 of the second bar set 29 all point in the same rotational direction as the engagement faces 43 of those bars 30 (clockwise in FIG. 6). Likewise, the tails 16 are matched with the ramps 45. This ensures that the guard mechanism 2 is bi-directional so whether the first or second set of engagement bars 27,29 attempt to engage the dogs 19 initially, the guard mechanism 2 prevents damaging contact between the bars 28,30 and the dogs 19.

The fore portion 14 of each guard arm includes first and second operative surfaces 18,20. The first operative surface 18 is arranged to cause the guard arm 6 to rotate about the pivot pin 10 when it contacts one of the dogs 19 and thereby allow the engagement bar 28 to engage with one of the dogs 19. The first operative surface 18 is the leading surface of the guard arm 6 as it rotates in the direction of the fore portion 14 and is formed helically so that the first operative surface 18 contacts the dog 19 face to face rather than at a point, to reduce the amount of wear that occurs. The first operative surface 18 is inclined forwards such that its upper part precedes its lower part when rotating in the direction of the fore portion 14. The second operative surface 20 is formed in the side 24 of the guard arm and is arranged to move the engagement bar 28 axially along the output shaft 1 away from the first gear wheel 3 when it contacts one of the dogs 19, thereby preventing the engagement bar 28 from engaging with the dog 19. The second operative surface 18 is formed helically to reduce the amount of wear that occurs.

The fore portion 14 of each guard arm tapers from the main body of the guard arm towards the first operative surface 18 (as can be seen when the outer surface is viewed from above). The side 24 of each arm that faces the gear wheel 3 includes a ramped surface 26 and a recess 34 located between the ramped surface 26 and the first operative surface 20. The ramped surface 26 and the recess 34 prevent the dogs 19 from locking with the guard arms 6 thereby preventing the transmission from jamming. The recess 34 ensures that the corners of the dogs 19 do not lock with the second operative surface 20 towards its leading edge. The fore portion 14 of each guard arm also includes a second ramped surface 32 on the inner side. The second ramped surface 32 provides a small amount of clearance between the guard arm 6 and the dog 19 when the engagement bars 28,30 engage the gear wheel 3. This is particularly useful when a second set of engagement bars moves into engagement with the gear wheel as it provides clearance between the guard arms 6 mounted thereon and the dogs 19.

The springs 12 are mounted on the pivot pins 10 and cause the fore portions 14 of the guard arms to be biased downwards towards the upper surfaces of the engagement bars 28,30 (i.e. into a protective position) and the tails 16 to be biased towards their outermost position. The upper surfaces of the engagement bars 28,30 act as stops to prevent further rotational movement of the guard arms in the biased direction. Each guard arm 6 includes a through hole 36. One end of each spring 12 is located in each hole 36 to securely locate the springs in place. The springs 12 act as shock absorbers and can be arranged to absorb a significant proportion of the energy of the initial impact from the engagement bars 28,30. For example, the stiffness of the springs can be selected so that they absorb up to around 75% of the energy from the engagement bars 28,30. Therefore when the engagement members 28,30 contact the dogs 19 the energy of the impact will be much reduced, thereby reducing the amount of wear that can occur. The strength of the springs 12 can be optimised for different applications to absorb different amounts of energy, for example to provide a soft start.

The tails 16 of the guard arms extend over the engagement bars 28,30. The tails 16a of the guard arms mounted on the engagement bars 28 of the first bar set 27 mate with the tails 16b of the guard arms mounted on one of the adjacent engagement bars 30 of the second bar set 30, thus forming three guard arm pairs. The arrangement is such that when one of the guard arms 6 of a guard arm pair is caused to rotate due to engagement of the first operative face with one of the dogs 19, the mating configuration of the tails 16a,16b causes the other guard arm 6 of the guard arm pair to rotate substantially synchronously therewith. The tails 16a, 16b rotate inwards until they abut the outer surface 2a of the sleeve in which the keyways 41 are formed, thereby limiting rotation of the guard arms 6. Parts of the outer surface 2a of the sleeve have concave formations to accommodate the tails 16a,16b. If there is relative rotational movement between the dog 19 and the guard arm 6 in the opposite direction thus allowing the bias of the spring 12 to return the guard arm 6 towards its start position, the other guard arm 6 of the guard arm pair likewise moves towards its start position. This synchronous movement of guard arm pairs is important since when there is a gear change one of the sets of engagement bars (the unloaded set) will move axially along the output shaft 1 towards engagement with the dogs on the first gear wheel 3. The guard arms 6 mounted on those engagement bars will collide with the dogs 19 and rotate outwards to allow the bars to engage the dogs 19. The other guard arms 6 in each guard arm pair are substantially simultaneously rotated outwards due to the tail mating arrangement, thereby providing windows for the bars of the other engagement bar set to move into when they become unloaded from the second gear wheel 5.

The width of the tails ‘Z’ (see FIG. 7) is governed by the amount of axial movement of the engagement bars 28,30 along the output shaft 1 since the tails 16a,16b of a guard arm pair must remain in mating engagement regardless of the relative axial positions of the respective engagement bars 28,30 on which the guard arms 6 are mounted, i.e. they must remain in mating engagement when the first bar set 27 is engaged with one of the gear wheels 3,5 and the second bar set 29 is engaged with the other gear wheel.

In use, when a gear change is selected one of the engagement bar sets 27,29 (the unloaded set) moves out of engagement with the second gear wheel 5 and tries to engage the dogs 19 on the first gear wheel 3. The unloaded bar set will be determined by whether the gear selection is an up-shift or a downshift. Since the relative rotational positions of the engagement bars in the bar set and the dogs 19 on the first gear wheel 3 are not controlled, and the relative rotational speeds are not matched, one of the following could occur: (1) the end faces 42 or the ramps 45 of the engagement bars collide with the dogs 19; (2) the second operative surfaces 20 of the guard arms collide with the dogs 19; or (3) the engagement bars enter the windows between the dogs 19 and rotate towards the dogs 19 until the first operative surfaces 18 of the guard arms impact the dogs 19 and rotate outwards to allow the engagement faces 43 of the bars to fully engage with the dogs 19.

In the first instance corner to corner contact between the engagement bars and the dogs 19, which is the most damaging type of contact, is avoided because the engagement faces 43 are already past the edges of the dogs 19 and the end faces of the bars 42 and the ramps 45 slide over the upper surfaces of the dogs 19. When bars have moved passed those dogs 19 they enter the windows between those dogs 19 and the next dogs 19 along the rotational path. The bars then fully engage the next dogs 19 in the manner described in the third instance. In the second instance corner to corner contact between the engagement bars and the dogs 19 is avoided since the dogs 19 collide with the second operative surfaces 20 of the guard arms, which shield the engagement faces 43 of the bars. FIGS. 8 and 9 illustrate this from different perspectives. As the dogs 19 rotate relative to the second operative surfaces 32 and slide along them, the engagement bar set is forced to move axially along the output shaft 1 away from the first gear wheel 3 against the action of the actuator assembly 31. This ensures that there is clearance between the dogs 19 and the engagement faces 43 as they align and hence the engagement bars pass the dogs 19 without engaging them. The end faces 42 and the ramps 45 slide over the upper surfaces of the dogs 19. When the bars have moved passed those dogs 19 they enter the windows between those dogs 19 and the next dogs 19 along the rotational path. The bars fully engage the next dogs 19 in the manner described in the third instance. In the third instance the impact between the dogs 19 and the first operative surface 18 of the guard arms causes the guard arms 6 to rotate on pivot pins 10 such that the fore portions 14 of the guard arms rotate outwards, i.e. away from the output shaft 1 against the bias of the springs 12 (see FIG. 10). The guard arms 6 no longer shield the engagement bars, and so the engagement faces 43 of the bars engage the dogs 19 (see FIG. 11). Since the tails 16a,16b of each guard aim pair are in a mating relationship and the guard arms 6 mounted on the set of engagement bars are still engaged with the second gear wheel 5, the guard arms 6 on those engagement bars rotate simultaneously with those mounted on the engagement bars now engaged with the first gear wheel 3. This allows the other bars to move into engagement with the first gear wheel 3 when they disengage the second gear wheel 5 to complete the gear selection.

When a second gearshift is initiated and the engagement bars move out of engagement with the first gear wheel 3, the resiliency of the springs 12 causes the guard arms 6 to return to their start position.

The second guard mechanism 2 is similarly arranged for the second gear wheel 5 and operates in a similar manner to the guard mechanism for the first gear wheel 3.

The actuator assembly 31 is arranged such that the fork assembly 33 is mounted on the selector rod 35, and the selector rod is provided parallel to the output shaft 1 and adjacent thereto. The fork assembly 33 includes a fork 46 and an annular disc spring 47 mounted about the output shaft 1 (see FIG. 1). The disc spring 47 has six arms, with each arm having a first part that extends circumferentially around a part of the spring and a second part that extends radially inwards (see FIG. 12).

The fork 46 has a pair of arcuate members 51 arranged to engage the disc spring 47. The arcuate members 51 are arranged such that the disc spring 47 can rotate with the output shaft 1 between the arcuate members 51 and such that axial movement of the fork 46 parallel to the output shaft 1 moves the arcuate members 51 and hence the disc spring 47 axially along the shaft if the disc spring 47 is free to move, or biases the disc spring 47 to move in the same direction as the fork 46 if the disc spring 47 is unable to move.

The position of the fork 46 relative to the first and second gear wheels 3,5 can be adjusted by movement of the selector rod 35, for example via a gear stick 35a, in the axial direction.

The inner edges of the disc spring 47 are attached to the bars 28,30 in the first and second bar sets 27,29 via the guard arm supports 8. A recess 8a is formed in the upper surface of each guard arm support. The recesses 8a allow connections to be made between the bars 28,30 and the aims of the disc spring 47. The shape of the recesses 8a is such that they allow each spring arm to move to a non-perpendicular angle relative to the bars 28,30 during a gearshift. When the fork 46 moves, thereby moving or loading the disc spring 47, the engagement bar sets 27,29 are likewise moved or biased to move.

In use, three of the bars are loaded when the first gear wheel 3 is accelerating and three are not loaded, and moving the fork 46 to bias the disc spring 47 towards the second gear wheel 5 moves the three unloaded bars out of engagement with the first gear wheel 3, leaving the three loaded bars still in engagement. Once the bars have engaged with the second gear wheel 5, the remaining three bars will disengage from the first gear wheel 3, and under the loading of the disc spring 47 move into engagement with the second gear wheel 5. This configuration provides a highly compact arrangement leading to smaller, lighter gearboxes. The axial space between the first and second gears to accommodate the selector mechanism may be reduced to around 20 mm for typical road car applications.

The bars in a set can move a small amount relative to each other in the axial direction. This is because the only connection between the bars in a set is provided by the deformable disc spring 47. A single bar is attached to each disc spring arm and each arm can deform independently of the others, thereby allowing the relative movement between the bars. The bars in a set nevertheless essentially move in unison.

The operation of the selector assembly 13 will now be described with reference to FIGS. 13a-13f which for clarity illustrate diagrammatically the movement of the first and second bar sets 27,29 by the relative positions of only one bar from each set.

FIG. 13a shows the first and second bar sets 27,29 in a neutral position, that is, neither bar set is engaged with a gear wheel. FIG. 13b shows the first and second bar sets moving into engagement with the first gear wheel 3 under the action of the fork 46 (not shown in FIG. 13b).

FIG. 13c shows a condition when the first gear wheel 3 is fully engaged, that is, the bars 28,30 are interleaved with the first group of dogs 19. The selector rod 35 is located such that the fork 46 maintains the first and second bar sets 27,29 in engagement with the first gear wheel 3. Accordingly, power is transferred to the output shaft 7 from the first gear wheel 3 by the first bar set 27 when decelerating and the second bar set 29 when accelerating via the first group of dogs 19. Power is transmitted from the input shaft 7 via the third gear wheel 9.

Whilst accelerating (first gear wheel 3 rotating in the direction of arrow B in FIG. 13c ) using the first gear wheel pair 15, the engagement faces 43 of the bars of the first bar set 27 are not loaded, whilst the engagement faces 43 of the bars of the second bar set 29 are loaded. When a user, or an engine management system (not shown) wishes to engage the second gear wheel pair 17, the selector rod 35 is moved such that the fork 46 acts on the disc spring 47, causing the bars of the first bar set 27 to slide axially along the keyways 41 in the sleeve 2 thereby disengaging the bars from the first gear wheel 3 (see FIG. 13d).

The fork 46 also causes the disc spring 47 to bias the bars of the second bar set 29 to move towards the second gear wheel 5. However, because the bars of the second bar set 29 are loaded, i.e. are driven by the first gear wheel 3, they cannot be disengaged from the first gear wheel 3, and therefore the bars of the second bar set 29 remain stationary.

When the bars of the first bar set 27 slide axially along the output shaft 1, the guard mechanism 2 operates as described above to prevent partial engagement of the second group of dogs 21, and collisions between the dogs 21 and the engagement bars 28 that may cause significant wear to the components. When the engagement bars 28 enter the windows between the dogs 21 the first operative surfaces 18 of the guard arms collide with the dogs 21 and rotate the guard arms 6 such that the fore portions 14 move outwards, i.e. away from the output shaft 1, to allow the engagement faces 43 to engage the dogs 21 (see FIG. 13e), and the tails 16a move inwards thereby simultaneously rotating the fore portions 14 of the other guard arms 6 of the guard arm pairs outwards to create windows for the bars 30 of the second bar set 29 to enter. The bars are then driven by the second gear wheel 5 in the direction of Arrow C in FIG. 13e and energy is transmitted to the output shaft 1 from the input shaft 7 by way of the second gear wheel pair 17. As this occurs, the bars of the second bar set 29 cease to be loaded, and are free to disengage from the first group of dogs 19. Since the disc spring 47 is biased by the fork 46, the bars of the second bar set 29 slide axially along the keyways 41 in the sleeve 2 thereby completing the disengagement of the first gear wheel 3 from the output shaft 1. The bars of the second bar set 29 slide along the keyways 41 in the sleeve 2 until they engage the second gear wheel 5, thereby completing engagement of the second gear wheel 5 with the output shaft l(see FIG. 13f). This method of selecting gear wheel pairs substantially eliminates torque interruption since the second gear wheel pair 17 is engaged before the first gear wheel pair 15 is disengaged, thus momentarily, the first and second gear wheel pairs 15,17 are simultaneously engaged.

When a gear wheel is engaged by both, the first and second bar sets 27,29 it is possible to accelerate or decelerate using a gear wheel pair with very little backlash occurring when switching between the two conditions. Backlash is the lost motion experienced when the dog moves from the engagement face 43 of the acceleration bar to the engagement face 43 of the deceleration bar when moving from acceleration to deceleration, or vice versa. A conventional dog-type transmission system has approximately 30 degrees of backlash. A typical transmission system for a car in accordance with the current invention has backlash of less than four degrees.

Backlash is reduced by minimising the clearance required between an engagement member and a dog during a gear shift: that is, the clearance between the dog and the following engagement member (see measurement ‘A’ in FIG. 13b). The clearance between the dog and the following engagement member is in the range 0.5 mm-0.03 mm and is typically less than 0.2 mm. Backlash is also a function of the retention angle, that is, the angle of the engagement face 43, which is the same as the angle of the undercut on the engagement face of the dog. The retention angle influences whether there is relative movement between the dog and the engagement face 43. The smaller the retention angle, the less backlash that is experienced. The retention angle is typically between 2.5 and 15 degrees, and preferably is 15 degrees.

Transition from the second gear wheel pair 17 to the first gear wheel pair 15 whilst decelerating is achieved by a similar process.

Whilst decelerating in the second gear wheel pair 17 the engagement surfaces 43 of the bars of the first bar set 27 are not loaded, whilst the engagement surfaces 43 of the bars of the second bar set 29 are loaded. When a user, or an engine management system (not shown) wishes to engage the first gear wheel pair 15, the selector rod 35 is moved such that the fork 46 slides axially relative to the output shaft 1. The fork 46 acts on the disc spring 47, causing the bars of the first bar set 27 to slide axially in the keyways 41 along the output shaft 1 in the direction of the first gear wheel 3, thereby disengaging the first bar set 27 from the second gear wheel 5.

Since the bars of the second bar set 29 are loaded, i.e. they are drivingly engaged with the dogs 21 on the second gear wheel, the second bar set 29 remains stationary, however the disc spring 47 biases the second bar set 29 towards the first gear wheel 3.

As the bars of the first bar set 27 slide axially in the keyways 41, the guard mechanism 2 operates as described above to prevent partial engagement of the first group of dogs 19, and collisions between the dogs 19 and the engagement bars 28 that may cause significant wear to the components. When the engagement bars 28 successfully enter the windows between the dogs 19 the first operative surfaces 18 of the guard arms collide with the dogs 19 and rotate the guard arms 6 such that the fore portions 14 move outwards, i.e. away from the output shaft 1, to allow the engagement faces 43 to engage the dogs 19, and the tails 16a move inwards thereby simultaneously rotating the fore portions 14 of the other guard arms 6 of the guard arm pairs outwards to create windows for the bars 30 of the second bar set 29 to enter. The bars 28 are driven by the first gear wheel 3 such that energy is transmitted from the input shaft 7 to the output shaft 1 by way of the first gear wheel pair 15. As this occurs, the bars 30 of the second bar set 29 cease to be loaded. The disc spring 47 acts on the bars 30 of the second bar set 29, causing them to slide axially within the keyways 41 along the output shaft 1 towards the first gear wheel 3, thereby completing disengagement of the second gear wheel 5. The second bar set 29 continues to slide within the keyways 41 along the output shaft 1 until it engages the first gear wheel 3, thereby completing engagement of the first gear wheel 3 with the output shaft 1.

Kick-down shifts, that is a gear shift from a higher gear to a lower gear but where acceleration takes place, for example when a vehicle is travelling up a hill and the driver selects a lower gear to accelerate up the hill, may have a brief torque interruption to allow disengagement prior to the shift.

A plurality of selector assemblies can be mounted on the output shaft with corresponding pairs of gear wheels to provide a larger number of gear ratios between the output shaft and the input shaft. It is also possible to have transmission systems with more than two shafts to provide additional gear ratios.

Use of the transmission system leads to improved performance, lower fuel consumption and lower emissions since drive interruption has substantially been eliminated. Also the system is a more compact design than conventional gearboxes leading to a reduction in gearbox weight.

The guard mechanisms 2 can be used with transmission systems that use two disc springs, i.e. one disc spring having three arms for each bar set (see FIG. 14) such as the transmission of PCT/GB2004/001976 and bar-sets that use retainer rings to hold the bars in a set in a fixed relationship (see FIG. 15).

In a second embodiment of the invention, the guard mechanisms 102 are mounted on the first and second gear wheels. The guard mechanisms 102 for each gear wheel are similar. The guard mechanism 102 for the first gear wheel will now be described with reference to FIGS. 16 to 19.

The first gear wheel 103 has a through hole 103a formed co-axially with the gear wheel 103, a recess 103b formed in one side of the gear wheel substantially concentrically with the hole 103a that defines a planar surface 103c and a curved surface 103d. Three blind holes 103e are formed in the flat surface 103c. The holes 103e are uniformly angularly spaced on the flat surface 103c and are arranged to receive arcuate lugs 103f. A hub 149 is located in the hole 103a and is welded to the non-recessed side of the gear wheel 103. The arrangement of the hub 149 and the gear wheel 103 is such that an annular groove is formed between the outer surface of the hub and the curved surface of the recess 103d, and the lugs 103f are located within the groove. Alternatively, the hub 149 may be formed integrally with the gear wheel 103 and likewise the arcuate lugs 103f.

The hub 149 includes three dogs 119 on one side that are evenly distributed about the circumference of the hub such that each dog 119 is diametrically opposite an arcuate lug 103f. Arcuate recesses 151 are formed in the hub 149 between each pair of dogs 119, so that there are three in total. Each arcuate recess 151 includes a step 153 at each end with a threaded blind bore 155 formed therein. Each recess 151 has an arcuate cover 157 that is seated on the steps 153 and firmly attached to the hub 149 by screws 159.

A spring loaded guard ring 161 is located in the annular groove formed between the outer surface of the hub and the curved surface of the recess 103d, that is arranged for limited rotational movement relative to the hub 149. The guard ring 161 includes three retainer fingers 163. The retainer fingers 163 are located in the arcuate recesses 151 and they limit the relative rotational movement between the guard ring 161 and the hub 149 by abutting against the steps 153. The retainer fingers 163 also prevent the guard ring 161 from moving translationally relative to the hub 149.

The underside 165 of the guard ring includes three arcuate slots 167 that are arranged to receive one of the arcuate lugs 103f (see FIG. 17). Two compression springs 168 are located in each slot 167: one either side of the lug 103f. The arrangement is such that as the guard ring 161 is forced to rotate relative to the hub 149 in a clockwise direction, three of the compression springs 168 are compressed and they provide a reaction force to bias the guard ring 161 back towards a start (protective) position. If the guard ring 161 is forced to rotate relative to the hub 149 in an anti-clockwise direction the other three compression springs 168 are compressed and they provide a reaction force to bias the guard ring back towards the start position. The springs 168 act as shock absorbers and can be arranged to absorb a significant proportion of the energy of the initial impact from the engagement bars 28,30. For example, the stiffness of the springs can be selected so that they absorb up to around 75% of the energy from the engagement bars 28,30. Therefore when the engagement members 28,30 contact the dogs the energy of the impact will be much reduced, thereby reducing the amount of wear that can occur. The strength of the springs 168 can be optimised for different applications to absorb different amounts of energy, for example to provide a soft start. However, in each application the springs 168 need to be sufficiently stiff to be able to move the engagement members 28,30 away from the gear wheel 103 against the bias of the disc spring 47 (see below).

Six holes 171 are formed through the upper surface 173 of the guard ring. The holes 171 allow a tool to be inserted during assembly to compress the compression springs to allow the lugs 103f to be located correctly in place between the springs 169.

Six substantially trapezoidal guard members 106 are fixed to the inner surface 173 of the guard ring. The guard members 106 allow the engagement bars to engage the dogs 119 during predetermined windows of opportunity defined by the relative rotational positions of the engagement bars and the dogs 119, and prevent engagement when the relative rotational positions are outside of the windows of opportunity. Each guard member 106 has a flat surface 106a, and three operative surfaces 118,120,175: the first operative surface 118 is planar and is substantially complementary to the engagement faces of the engagement bars so that the first operative surface 118 contacts the engagement face surface to surface rather than point to point to reduce the amount of wear that occurs; the second operative surface 120 is preferably helically formed and is inclined from the first operative surface 118 to the flat surface 106a and is arranged to prevent corner to corner contact between the engagement bars and the dogs 119; and the third operative 175 surface is preferably helically formed and is located opposite the second operative surface 120 and is arranged to force the engagement bars over the guard members 106 without the transmission jamming when the engagement bars have passed the dogs 119 without engaging. Alternatively, the second and third operative surfaces 120,175 may be planar.

The guard members 106 are distributed about the guard ring 106 in pairs such that opposite handed guard members 106 are positioned either side each of the dogs 119. The first operative surfaces 118 of each guard member face away from the dog 119 and the third operative surfaces 175 towards the dog 119. That is, three of the first operative surfaces 118 (one from each pair of guard members) are complementary to the engagement faces of the bars of the first bar set and all point in the same rotational direction (clockwise in FIG. 16) and the other three operative surfaces 118 are complementary to the engagement faces of the bars of the second bar set and all point in the same rotational direction (anti-clockwise in FIG. 16). This ensures that the guard mechanism 102 is bi-directional so whether the first or second set of engagement bars engages the dogs 119 initially, the guard mechanism 102 prevents damaging contact between the bars and the dogs 119.

In use, when a new gear is selected one of the engagement bar sets (the unloaded set) moves out of engagement with the second gear wheel 105 and attempts to engage the dogs 119 on the first gear wheel 103. The unloaded bar set will be determined by whether the gear selection is an up-shift of a downshift. Since the relative rotational positions of the engagement bars in the bar set and the dogs 119 on the first gear wheel 103 are not controlled, and the relative rotational speeds are not matched, one of the following could occur: (1) the engagement bars enter the windows between the guard members 106 and rotate towards the dogs 19 into engagement with the first operative surfaces 118 forcing the guard ring 161 to rotate until the engagement faces of the bars fully engage the dogs 119; (2) the engagement bars collide with the second operative surfaces 120 of the guard members; or (3) the engagement bars collide with the upper surfaces of the dogs 119 and then slide into contact with the third operative surface 175.

In the first instance the engagement bars drive the guard members 106 and the guard ring 161 rotates against the resiliency of three of the springs such that the guard members 106 that are in contact with the engagement bars rotate into gaps 177 between the dogs 119 and the inner surface 173 of the guard ring and the engagement faces of the bars fully engage the dogs 119. The engagement bars are then driven by the first gear wheel 103 and energy is transferred to the output shaft 7 via the first gear wheel pair 15. The other guard members 106 of the guard member pairs rotate simultaneously with the guard ring 161 thereby opening windows for the bars of the other bar set to move in to complete the gear selection.

In the second instance the guard ring 161 is caused to rotate a few degrees when engagement bars collide with the second operative surfaces 120 and the springs act as shock absorbers. Corner to corner contact between the engagement bars and the dogs 119 is avoided since the engagement bars are caused to move axially along the output shaft away from the gear wheel 103 as they move over the second operative surfaces 120 to such an extent that the engagement faces of the bars clear the sides of the dogs thereby preventing collision. The end faces of the engagement bars then slide over the dogs 119 and the bars collide with the third operative surfaces 175 of the other guard member of the guard member pair. When this happens the guard ring 161 rotates a few degrees, the springs acting as shock absorbers, and the engagement bars are caused to move axially along the output shaft away from the gear wheel 103 as they move over the third operative surfaces 175 to clear the guard members 106.

The bars then move back towards the first gear wheel 103 thereafter. This also occurs in the third instance. The engagement bars move into the windows between the dogs 119 just cleared and the next dogs 119 move along the rotational path and fully engage the next dogs 119 in the manner described in the first instance.

When the engagement bars disengage from the first gear wheel 103 the resiliency of the compression springs returns the guard ring 161, and hence the guard members 106, to the start (protective) position.

The second guard mechanism 102 is similarly arranged for the second gear wheel and operates in a similar manner to the guard mechanism for the first gear wheel 103.

A third embodiment of the invention is shown in FIGS. 20 and 21. The guard mechanisms 202 for the first and second gear wheels are similar. The guard mechanism 202 for the first gear wheel 203 will now be described with reference to FIGS. 20 and 21. The guard mechanism 202 comprises six guard arms 206 (see FIG. 21). Each guard arm 206 is mounted on one of the engagement bars in the first and second engagement bar sets similarly to the first embodiment, except that the guard arms 206 are fixed to the upper surfaces of the engagement bars or formed integrally therewith, i.e. they do not rotate. The guard arms 206 allow the engagement bars to engage the dogs during predetermined windows of opportunity defined by the relative rotational positions of the engagement bars and the dogs 219, and prevent engagement when the relative rotational positions are outside of the windows of opportunity. The guard arms 206 each have a fore portion 214 and they are mounted on the engagement bars such that the fore portions 214 overhang the engagement bars thereby preceding the engagement bars and the fore portions 214 match with the engagement faces of the bars. That is, the fore portions 214 of the guard arms mounted on the bars of the first bar set all point in the same rotational direction as the engagement faces of those bars and the fore portions 214 of the guard arms mounted on the bars of the second bar set all point in the same rotational direction as the engagement faces of those bars. This ensures that the guard mechanism 202 is bi-directional so whether the first or second set of engagement bars attempts to engage the dogs 219 initially, the guard mechanism 202 prevents damaging contact between the bars and the dogs 219.

The fore portion 214 of each guard arm resembles an asymmetrical arrowhead with a rounded tip, having first and second operative surfaces 218,220. The first operative surface 218 is arranged to engage a complementary surface 219b formed in the dog when one of the engagement bars successfully engages the dogs 219 and is the inner inclined surface of the arrowhead. The second operative surface 220 is the outer inclined surface of the arrowhead and is arranged to prevent the engagement bar from engaging the dog 219 when it contacts a complementary surface 219c formed in the dog.

In use, when a gear change is selected one of the engagement bar sets (the unloaded set) moves out of engagement with the second gear wheel 205 and tries to engage the dogs 219 on the first gear wheel 203. The unloaded bar set will be determined by whether the gear selection is an up-shift or a downshift. Since the relative rotational positions of the engagement bars in the bar set and the dogs 219 on the first gear wheel 203 are not controlled, and the relative rotational speeds are not matched, one of the following could occur: (1) the end faces or the ramps of the engagement bars collide with the dogs 219; (2) the second operative surfaces 220 of the guard arms collide with the complementary surfaces 219c formed in the dogs; or (3) the engagement bars enter the windows between the dogs 219 and rotate towards the dogs 219 until the first operative surfaces 218 of the guard arms impact the complementary surfaces 219b formed in the dogs.

In the first instance corner to corner contact between the engagement bars and the dogs 219 is avoided because the engagement faces are already past the edges of the dogs 219 and the end faces of the bars and the ramps slide over the upper surfaces of the dogs 219. When bars have moved passed those dogs 219 they enter the windows between those dogs 219 and the next dogs 219 along the rotational path and fully engage with the next dogs 219 in the manner described in the third instance. In the second instance corner to corner contact between the engagement bars and the dogs 219 is avoided since the second operative surfaces 220 of the guard arms collide with the complementary surfaces 219c formed in the dogs. As further relative rotation takes place, the surfaces 219c formed in the dogs causes the engagement bar set to move axially along the output shaft 201 away from the first gear wheel 203 against the action of the actuator assembly. This ensures that there is clearance between the dogs 219 and the engagement faces as they align and hence the engagement bars pass the dogs 219 without engaging therewith. The end faces and the ramps slide over the upper surfaces of the dogs 219. When the bars have moved passed those dogs 219 they enter the windows between those dogs 219 and the next dogs 219 along the rotational path. The bars fully engage with the next dogs 219 in the manner described in the third instance.

In the third instance the guard arms 206 rotate into an undercut portion 219d formed in the dogs. If the engagement bars have not moved to their fullest axial extent, the first operative surfaces 218 engage with the complementary surfaces 219b formed in the dogs and slide over those surfaces as the engagement bars rotate into full engagement with the dogs. When the engagement faces fully engage the dogs 219 the gear wheel 203 is then driven by the engagement bars and power is transmitted through the first gear ratio to the output shaft 207.

When a second gear shift is initiated and the unloaded bar set moves out of engagement with the first gear wheel 203 the interaction between the fore portion 214 of the guard arms and the profiled portions of the dogs cause the engagement faces to move rotationally away from the dogs 219 thereby creating a gap between them and hence disengaging the engagement faces of the bars from the dogs. This is advantageous since it prevents the engagement bars from colliding with the dogs 219 when they disengage from the gear wheel 203.

The second guard mechanism 202 is similarly arranged for the second gear wheel 205 and operates in a similar manner to the guard mechanism for the first gear wheel 203.

FIGS. 22 and 23 show views of an engagement bar according to a fourth embodiment of the invention. The fourth embodiment of the invention is similarly arranged to the third embodiment except that the guard arms are fixed to the dogs and the engagement bars 328,330 include profiled portions 318,320 to engage operative surfaces formed in the guard arms. The operation of the fourth embodiment is similar to the third embodiment.

It will be appreciated by the skilled person that various modifications can be made to the above embodiments that are within the scope of the current invention, for example the number of dogs on each of the gear wheels is not limited to three, for example any practicable number of dogs can be used. It has been found that two to eight dogs are suitable for most applications. Similarly, the number of bars in a bar set can be any practicable number but most preferably the number of bars in a set equals the number of dogs in a group.

The transmission system can be used in any vehicle for example, road cars, racing cars, lorries, motorcycles, bicycles, earth removal vehicles such as bulldozers, cranes, military vehicles, aircraft such as aeroplanes and helicopters, watercrafts such as boats, ships and hovercraft and other machines such as lathes and milling machines.

It will also be appreciated by the skilled person that the transmission system can be adapted such that the selector assembly and the first and second gear wheels are mounted on the input shaft and the fixed gear wheels are mounted on the output shaft.

Different embodiments of the guard mechanism can be included in a single transmission system, for example a guard mechanism according to the first embodiment can be used for the first gear wheel and a guard mechanism according to another embodiment can be used for the second gear wheel. Alternatively, for transmission systems having more than one selector assembly different guard mechanisms can be used for each selector assembly.

Different shaped guard members/guard arms can be used to obtain similar control of the relative positions of the dogs and the engagement bars.

The guard mechanisms described above can be used with conventional dog transmission systems. A gear wheel 403 with six dogs 419 mounted thereon and a dog ring 427 from a conventional dog ring transmission is illustrated in FIG. 24. The system includes a fork 446 having axial compliance to allow the guard mechanisms to repel the dog ring 427 if it attempts to engage the dogs 419 from a relative rotational position with the, potential for a partial engagement or damaging dog ring 427 to dog 419 contact. Although in conventional dog transmissions the drive source (engine) is disconnected from the transmission when a gear change is made, under certain conditions it is still possible for the engagement bars and the dogs to collide and cause significant wear. This is particularly the case in high performance vehicles. Use of the guard mechanisms described above can significantly reduce the amount of wear in conventional dog type transmissions.

It will be appreciated by the skilled person that the guard device can be used in applications other than vehicle transmission systems. The guard devices can be used in any suitable machines having at least one coupling arrangement for coupling first and second rotatable bodies together. For example, it may be used in any machine that has coupling formations to connect first and second rotatable bodies together and wherein the rotatable bodies may be coupled together when they have different rotational speeds such as for transferring drive between, a shaft and a pulley wheel, a shaft and a roller, a shaft and a machine chuck, a shaft connected to any rotatable load, between two similar components such as two shafts, a shaft and a gear wheel, a drive member to a device such as a pump, and a drive member to a cam shaft or cam. In particular, but not exclusively, the invention can be used in any dog type drive system, for example where two rotatable components are connected by dog type formations associated with each rotatable component, such as two shafts each having dogs formed in their end faces or having coupling components mounted on the shafts. Usually at least one of the shafts is moveable towards the other shaft such that the coupling formations can engage. Alternatively, the coupling formations may be separate components that can selectively move into and out of engagement with one or both of the rotatable bodies.

1. A coupling device including first and second rotatable bodies, a plurality of engagement members for selectively coupling the first and second rotatable bodies together to transfer drive between the rotatable bodies, and a guard device for preventing the engagement members from coupling the rotatable bodies in certain predetermined operational conditions that include certain relative rotational positions of the rotatable bodies.

2. A coupling device according to claim 1, wherein the guard device includes at least one guard element for restricting movement of at least one of the engagement members.

3. A coupling device according to claim 2, wherein the or each guard element includes an actuator part arranged to co-operate with either the engagement members or one of the rotatable bodies wherein the engagement members couple the rotational bodies after the actuator part co-operates with either the engagement members or one of the rotatable bodies.

4. A coupling device according to claim 2, wherein the or each guard element includes a guard part arranged to co-operate with either the engagement members or one of the rotatable bodies the engagement members are restricted from coupling the rotatable bodies after the guard part co-operates with either the engagement members or one of the rotatable bodies.

5. A coupling device according to claim 2, wherein the or each guard element is arranged to cause separation between at least one engagement member and one of the rotatable bodies.

6. A coupling device according to claim 5, wherein the or each guard element is arranged to cause the separation according to the relative rotational positions of the engagement members and at least one of the rotational bodies.

7. A coupling device according to claim 2, wherein each of the engagement members includes a guard element mounted thereon.

8. A coupling device according to claim 7, wherein each guard element is pivotally mounted on the engagement member.

9. A coupling device according to claim 8, wherein each guard element is arranged to move between a first operative position in which it restricts movement of the engagement member and a second operative position in which it does not restrict movement of the engagement member.

10. A coupling device according to claim 9, including resilient means for biasing each guard element into the first operative position.

11. A coupling device according to claim 8, including a plurality of guard elements wherein pairs of guard elements are arranged to interact such that rotational movement of one of the pair of guard elements causes rotational movement of the other guard element.

12. A coupling device according to claim 8, wherein at least one of the rotatable bodies includes profiled parts that are complementary to the actuator part of the guard element.

13. A coupling device according to claim 8, wherein at least one of the rotatable bodies includes profiled parts that are complementary to the guard part of the guard element.

14. A coupling device according to claim 2, wherein the guard element is mounted on an annular member.

15. A coupling device according to claim 14, wherein the or each guard element is substantially trapezoidal.

16. A coupling device according to claim 15, wherein the or each guard element includes a guide part arranged to guide the engagement members over the or each guard element.

17. A coupling device according to claim 14, including resilient means for resisting relative rotational movement between the annular member and at least one of the rotatable bodies.

18. A coupling device according to claim 2, wherein the or each guard element is mounted on at least one of the rotatable bodies.

19. A coupling device according to claim 18, wherein the engagement members include profiled parts that are complementary to the or each guard element.

20. A transmission system including first and second drive shafts, first and second gear sets mounted on the shafts for transferring drive between the shafts, each gear set including a first gear wheel mounted on the first shaft for rotation relative to the first shaft said first gear wheel having a plurality of drive formations, and a second gear mounted on the second shaft for rotation with the second shaft, selector means for selectively transferring drive between the first shaft and either the first or second gear set including a plurality of engagement members for engaging the drive formations, and a guard device for preventing the engagement members from engaging the drive formations in certain predetermined operational conditions that include the relative rotational positions of the drive formations and the engagement members.

21. A transmission system according to claim 20, wherein the guard device includes a plurality of guard elements for restricting movement of the engagement members.

22. A transmission system according to claim 21, wherein each guard element includes an actuator arranged to co-operate with either the engagement members or the drive formations, wherein the engagement members fully engage the drive formations after the actuator part co-operates with either the engagement members or the drive formations.

23. A transmission system according to claim 20, wherein each guard element includes a guard part arranged to co-operate with either the engagement members or the drive formations, wherein the engagement members are restricted from engaging the drive formations after the guard part co-operates with either the engagement members or the drive formations.

24. A transmission system according to claim 21, wherein the guard elements are arranged to cause separation between the engagement members and the drive formations.

25. A transmission system according to claim 24, wherein the guard elements are arranged to determine the separation according to the relative rotational positions of the drive formations and the engagement members.

26. A transmission system according to claim 21, including first and second guard elements associated with each drive formation, wherein the first guard element is arranged to restrict movement of engagement members approaching the drive formation from a first rotational direction and the second guard element is arranged to restrict movement of engagement members approaching the drive formation from a second rotational direction.

27. A transmission system according to claim 21, wherein each of the engagement members includes a guard element mounted thereon.

28. A transmission system according to claim 27, wherein each guard element is pivotally mounted on the engagement member.

29. A transmission system according to claim 28, wherein each guard element is arranged to move between a first operative position in which it can restrict movement of the engagement member and a second operative position in which it cannot restrict movement of the engagement member.

30. A transmission system according to claim 29, including resilient means for biasing each guard element into the first operative position.

31. A transmission system according to claim 28, wherein pairs of guard elements are arranged to interact such that rotational movement of one of the guard elements in the guard element pair causes rotational movement of the other guard element.

32. A transmission system according to claim 28, wherein the drive formations include profiled parts that are complementary to the actuator part of the guard element.

33. A transmission system according to claim 28, wherein the drive formations include profiled parts that are complementary to the guide part of the guard element.

34. A transmission system according to claim 20, wherein the guard elements are mounted on an annular member.

35. A transmission system according to claim 34, wherein the guard elements are substantially trapezoidal.

36. A transmission system according to claim 34, wherein each guard element includes a guide part arranged to guide the engagement members over the guard elements.

37. A transmission system according to claim 34, including resilient means for resisting relative rotational movement between the annular member and the first gear wheel.

38. A transmission system according to claim 20, wherein the guard elements are mounted on the drive formations.

39. A transmission system according to claim 38, wherein the engagement members include profiled parts that are formed complementary to the guard elements.
